(19) United States
(12) Patent Application Publication
(10) Pub. No.: US 2009/0259971 A1
(43) Pub. Date: Oct. 15, 2009

(54) Media mashing across multiple heterogeneous platforms and devices

(76) Inventors: Scott Rankine, Toronto (CA); Dale Darling, Toronto (CA); Prasad Maruvada, Toronto (CA)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/284,468

(22) Filed: Sep. 22, 2008

Related U.S. Application Data
(60) Provisional application No. 60/994,751, filed on Sep. 21, 2007.
(60) Provisional application No. 60/994,956, filed on Sep. 24, 2007.

(51) Int. Cl. G06F 3/048

(52) U.S. Cl. 715/810

(57) ABSTRACT

Systems and methods providing for improved navigation and aggregation of a multiplicity of Internet based media and communication types are disclosed herein. In various embodiments, a Internet experience Manager (IEM) is adapted to present, to a user, a user interface. The user interface is defined in an interface window. The user interface includes a playback window, a graphic control interface, and an icon pallet. In an embodiment, the graphic control interface and the icon palette are adapted to operate together to enable the user to manipulate a selectable plurality of graphically manipulable icons within the user interface window such that the items of digital content associated with each of the plurality of icons are aggregated and managed as a collective in response to the graphic control interface.

### RELATED APPLICATIONS

The present invention claims priority to U.S. Provisional Patent Application No. 60/994,751, entitled “Ubiquitous Media Mashing Interface Across Multiple Heterogeneous Platforms and Devices,” filed Sep. 21, 2007 and U.S. Provisional Patent Application No. 60/994,956, entitled “Media Mashing Across Multiple Heterogeneous Platforms and Devices” filed Sep. 24, 2007, both of which are hereby incorporated by reference.

### Compact Disc

A compact disc containing codes and information describing embodiments of the present invention is submitted herewith and is hereby incorporated by reference. The compact disc contains the following files and/or programs.

| | | Size in | Date of |
|---|---|---|---|
| Title | | Bytes | Creation |
| 1. | flash\as\com\erwinverdonk\flash\effects\Reflection.as | 7150 | 9/19/2007 |
| | | | 16:03 |
| 2. | flash\as\com\erwinverdonk\flash\effects\vssver2.scc | 120 | 9/20/2007 |
| | | | 10:54 |
| 3. | flash\as\com\metaradar\applications\Radar.as | 11930 | 9/19/2007 |
| | | | 16:03 |
| 4. | flash\as\com\metaradar\applications\RadarUI.as | 12280 | 9/19/2007 |
| | | | 16:03 |
| 5. | flash\as\com\metaradar\applications\vssver2.scc | 130 | 9/20/2007 |
| | | | 10:54 |
| 6. | flash\as\com\metaradar\consolemanager\ConsoleManager.as | 16360 | 9/19/2007 |
| | | | 16:03 |
| 7. | flash\as\com\metaradar\consolemanager\ConsoleManagerConnection.as | 9400 | 9/19/2007 |
| | | | 16:03 |
| 8. | flash\as\com\metaradar\consolemanager\ConsoleManagerUpdate.as | 1780 | 9/19/2007 |
| | | | 16:03 |
| 9. | flash\as\com\metaradar\consolemanager\ConsoleState.as | 1320 | 9/19/2007 |
| | | | 16:03 |
| 10. | flash\as\com\metaradar\consolemanager\vssver2.scc | 230 | 9/20/2007 |
| | | | 10:54 |
| 11. | flash\as\com\metaradar\consoles\device\DeviceConsole.as | 7500 | 9/19/2007 |
| | | | 16:03 |
| 12. | flash\as\com\metaradar\consoles\device\DeviceController.as | 5180 | 9/19/2007 |
| | | | 16:03 |
| 13. | flash\as\com\metaradar\consoles\device\DeviceModel.as | 18730 | 9/19/2007 |
| | | | 16:03 |
| 14. | flash\as\com\metaradar\consoles\device\DeviceModelUpdate.as | 3460 | 9/19/2007 |
| | | | 16:03 |
| 15. | flash\as\com\metaradar\consoles\device\DeviceView.as | 60980 | 9/19/2007 |
| | | | 22:38 |
| 16. | flash\as\com\metaradar\consoles\device\vssver2.scc | 250 | 9/20/2007 |
| | | | 10:54 |
| 17. | flash\as\com\metaradar\database\Database.as | 4490 | 9/19/2007 |
| | | | 16:03 |
| 18. | flash\as\com\metaradar\database\DatabaseUpdate.as | 920 | 9/19/2007 |
| | | | 16:03 |
| 19. | flash\as\com\metaradar\database\vssver2.scc | 140 | 9/20/2007 |
| | | | 10:54 |
| 20. | flash\as\com\metaradar\mvc\AbstractController.as | 1920 | 9/19/2007 |
| | | | 16:03 |
| 21. | flash\as\com\metaradar\mvc\AbstractModel.as | 850 | 9/19/2007 |
| | | | 16:03 |
| 22. | flash\as\com\metaradar\mvc\AbstractView.as | 2590 | 9/19/2007 |
| | | | 16:03 |
| 23. | flash\as\com\metaradar\mvc\Controller.as | 780 | 9/19/2007 |
| | | | 16:03 |
| 24. | flash\as\com\metaradar\mvc\Model.as | 780 | 9/19/2007 |
| | | | 16:03 |
| 25. | flash\as\com\metaradar\mvc\View.as | 770 | 9/19/2007 |
| | | | 16:03 |
| 26. | flash\as\com\metaradar\mvc\vssver2.scc | 250 | 9/20/2007 |
| | | | 10:54 |
| 27. | flash\as\com\metaradar\panels\BannerAdPanel.as | 5990 | 9/19/2007 |
| | | | 16:03 |
| 28. | flash\as\com\metaradar\panels\BlogPanel.as | 32710 | 9/20/2007 |
| | | | 12:01 |
| 29. | flash\as\com\metaradar\panels\BrowserPanel.as | 6500 | 9/19/2007 |
| | | | 20:17 |
| 30. | flash\as\com\metaradar\panels\MenuPanel.as | 87890 | 9/20/2007 |
| | | | 10:54 |
| 31. | flash\as\com\metaradar\panels\PhotoPanel.as | 15360 | 9/19/2007 |
| | | | 16:03 |
| 32. | flash\as\com\metaradar\panels\ToolsPanel.as | 11750 | 9/19/2007 |
| | | | 16:03 |
| 33. | flash\as\com\metaradar\panels\VideoPanel.as | 27940 | 9/19/2007 |
| | | | 16:03 |
| 34. | flash\as\com\metaradar\panels\vssver2.scc | 280 | 9/20/2007 |
| | | | 11:19 |
| 35. | flash\as\com\metaradar\services\content\Content.as | 99930 | 9/19/2007 |
| | | | 17:56 |
| 36. | flash\as\com\metaradar\services\content\ContentConnection.as | 16070 | 9/19/2007 |
| | | | 17:56 |
| 37. | flash\as\com\metaradar\services\content\ContentItem.as | 2430 | 9/19/2007 |
| | | | 16:03 |
| 38. | flash\as\com\metaradar\services\content\ContentTypes.as | 660 | 9/19/2007 |
| | | | 16:03 |
| 39. | flash\as\com\metaradar\services\content\ContentUpdate.as | 2460 | 9/19/2007 |
| | | | 16:03 |
| 40. | flash\as\com\metaradar\services\content\IContent.as | 6170 | 9/19/2007 |
| | | | 17:14 |
| 41. | flash\as\com\metaradar\services\content\IContentObserver.as | 1550 | 9/19/2007 |
| | | | 16:03 |
| 42. | flash\as\com\metaradar\services\content\Session.as | 980 | 9/19/2007 |
| | | | 16:03 |
| 43. | flash\as\com\metaradar\services\content\vssver2.scc | 330 | 9/20/2007 |
| | | | 10:54 |
| 44. | flash\as\com\metaradar\services\diagnostics\Diagnostics.as | 4980 | 9/19/2007 |
| | | | 16:03 |
| 45. | flash\as\com\metaradar\services\diagnostics\DiagnosticsObserverProxy.as | 2440 | 9/19/2007 |
| | | | 16:03 |
| 46. | flash\as\com\metaradar\services\diagnostics\DiagnosticsProxy.as | 6650 | 9/19/2007 |
| | | | 16:03 |
| 47. | flash\as\com\metaradar\services\diagnostics\DiagnosticsUpdate.as | 1790 | 9/19/2007 |
| | | | 16:03 |
| 48. | flash\as\com\metaradar\services\diagnostics\IDiagnostics.as | 1520 | 9/19/2007 |
| | | | 16:03 |
| 49. | flash\as\com\metaradar\services\diagnostics\IDiagnosticsObserver.as | 580 | 9/19/2007 |
| | | | 16:03 |
| 50. | flash\as\com\metaradar\services\diagnostics\vssver2.scc | 300 | 9/20/2007 |
| | | | 10:54 |
| 51. | flash\as\com\metaradar\services\liveupdate\LiveUpdate.as | 16740 | 9/19/2007 |
| | | | 16:03 |
| 52. | flash\as\com\metaradar\services\liveupdate\LiveUpdateUpdate.as | 1060 | 9/19/2007 |
| | | | 16:03 |
| 53. | flash\as\com\metaradar\services\liveupdate\samples\ver-01.00.0001\data\test.txt | 40 | 9/19/2007 |
| | | | 16:03 |
| 54. | flash\as\com\metaradar\services\liveupdate\samples\ver-01.00.0001\data\vssver2.scc | 140 | 9/20/2007 |
| | | | 10:54 |
| 55. | flash\as\com\metaradar\services\liveupdate\samples\ver-01.00.0001\radar.swf | 6170 | 9/19/2007 |
| | | | 16:03 |
| 56. | flash\as\com\metaradar\services\liveupdate\samples\ver-01.00.0001\test.exe | 1571110 | 9/19/2007 |
| | | | 16:03 |
| 57. | flash\as\com\metaradar\services\liveupdate\samples\ver-01.00.0001\update.xml | 610 | 9/19/2007 |
| | | | 16:03 |
| 58. | flash\as\com\metaradar\services\liveupdate\samples\ver-01.00.0001\version.xml | 270 | 9/19/2007 |
| | | | 16:03 |
| 59. | flash\as\com\metaradar\services\liveupdate\samples\ver-01.00.0001\vssver2.scc | 210 | 9/20/2007 |
| | | | 10:54 |
| 60. | flash\as\com\metaradar\services\liveupdate\vssver2.scc | 150 | 9/20/2007 |
| | | | 10:54 |
| 61. | flash\as\com\metaradar\settings\SettingIds.as | 2880 | 9/20/2007 |
| | | | 10:54 |
| 62. | flash\as\com\metaradar\settings\Settings.as | 8400 | 9/19/2007 |
| | | | 16:03 |
| 63. | flash\as\com\metaradar\settings\SettingsUpdate.as | 660 | 9/19/2007 |
| | | | 16:03 |
| 64. | flash\as\com\metaradar\settings\vssver2.scc | 170 | 9/20/2007 |
| | | | 10:54 |
| 65. | flash\as\com\metaradar\skins\hydrogen\DeviceSkin.as | 9000 | 9/19/2007 |
| | | | 23:12 |
| 66. | flash\as\com\metaradar\skins\hydrogen\vssver2.scc | 110 | 9/20/2007 |
| | | | 10:54 |
| 67. | flash\as\com\metaradar\skins\IRadar.as | 1630 | 9/19/2007 |
| | | | 16:03 |
| 68. | flash\as\com\metaradar\skins\IRadarSkin.as | 2210 | 9/19/2007 |
| | | | 16:03 |
| 69. | flash\as\com\metaradar\skins\ViewModes.as | 1050 | 9/19/2007 |
| | | | 16:03 |
| 70. | flash\as\com\metaradar\skins\vssver2.scc | 160 | 9/20/2007 |
| | | | 10:54 |
| 71. | flash\as\com\metaradar\utils\ConnectionNames.as | 2000 | 9/19/2007 |
| | | | 16:03 |
| 72. | flash\as\com\metaradar\utils\Connectivity.as | 750 | 9/19/2007 |
| | | | 16:03 |
| 73. | flash\as\com\metaradar\utils\Guid.as | 3040 | 9/19/2007 |
| | | | 16:03 |
| 74. | flash\as\com\metaradar\utils\HtmlUtils.as | 5740 | 9/19/2007 |
| | | | 16:03 |
| 75. | flash\as\com\metaradar\utils\Observable.as | 3800 | 9/19/2007 |
| | | | 16:03 |
| 76. | flash\as\com\metaradar\utils\Observer.as | 670 | 9/19/2007 |
| | | | 16:03 |
| 77. | flash\as\com\metaradar\utils\Preloader.as | 1470 | 9/19/2007 |
| | | | 16:03 |
| 78. | flash\as\com\metaradar\utils\RadarAds.as | 940 | 9/19/2007 |
| | | | 16:03 |
| 79. | flash\as\com\metaradar\utils\RadarConnection.as | 400 | 9/19/2007 |
| | | | 16:03 |
| 80. | flash\as\com\metaradar\utils\RadarDelegate.as | 1010 | 9/19/2007 |
| | | | 16:03 |
| 81. | flash\as\com\metaradar\utils\StartTween.as | 2410 | 9/19/2007 |
| | | | 16:03 |
| 82. | flash\as\com\metaradar\utils\Utils.as | 13780 | 9/19/2007 |
| | | | 16:03 |
| 83. | flash\as\com\metaradar\utils\vssver2.scc | 450 | 9/20/2007 |
| | | | 10:54 |
| 84. | flash\as\com\metaradar\utils\XTween.as | 2000 | 9/19/2007 |
| | | | 16:03 |
| 85. | flash\as\com\xfactorstudio\xml\xpath\Axes.as | 3180 | 9/19/2007 |
| | | | 16:03 |
| 86. | flash\as\com\xfactorstudio\xml\xpath\Operators.as | 630 | 9/19/2007 |
| | | | 16:03 |
| 87. | flash\as\com\xfactorstudio\xml\xpath\Token.as | 1520 | 9/19/2007 |
| | | | 16:03 |
| 88. | flash\as\com\xfactorstudio\xml\xpath\Tokenizer.as | 14020 | 9/19/2007 |
| | | | 16:03 |
| 89. | flash\as\com\xfactorstudio\xml\xpath\TokenTypes.as | 3820 | 9/19/2007 |
| | | | 16:03 |
| 90. | flash\as\com\xfactorstudio\xml\xpath\types\Axis.as | 660 | 9/19/2007 |
| | | | 16:03 |
| 91. | flash\as\com\xfactorstudio\xml\xpath\types\Func.as | 880 | 9/19/2007 |
| | | | 16:03 |
| 92. | flash\as\com\xfactorstudio\xml\xpath\types\Group.as | 690 | 9/19/2007 |
| | | | 16:03 |
| 93. | flash\as\com\xfactorstudio\xml\xpath\types\Identifier.as | 510 | 9/19/2007 |
| | | | 16:03 |
| 94. | flash\as\com\xfactorstudio\xml\xpath\types\Litteral.as | 130 | 9/19/2007 |
| | | | 16:03 |
| 95. | flash\as\com\xfactorstudio\xml\xpath\types\Num.as | 160 | 9/19/2007 |
| | | | 16:03 |
| 96. | flash\as\com\xfactorstudio\xml\xpath\types\Operator.as | 1250 | 9/19/2007 |
| | | | 16:03 |
| 97. | flash\as\com\xfactorstudio\xml\xpath\types\Path.as | 1310 | 9/19/2007 |
| | | | 16:03 |
| 98. | flash\as\com\xfactorstudio\xml\xpath\types\Predicate.as | 11020 | 9/19/2007 |
| | | | 16:03 |
| 99. | flash\as\com\xfactorstudio\xml\xpath\types\Query.as | 3350 | 9/19/2007 |
| | | | 16:03 |
| 100. | flash\as\com\xfactorstudio\xml\xpath\types\QueryPart.as | 1510 | 9/19/2007 |
| | | | 16:03 |
| 101. | flash\as\com\xfactorstudio\xml\xpath\types\vssver2.scc | 370 | 9/20/2007 |
| | | | 10:54 |
| 102. | flash\as\com\xfactorstudio\xml\xpath\vssver2.scc | 540 | 9/20/2007 |
| | | | 10:54 |
| 103. | flash\as\com\xfactorstudio\xml\xpath\XmlNodeSet.as | 3610 | 9/19/2007 |
| | | | 16:03 |
| 104. | flash\as\com\xfactorstudio\xml\xpath\XPath.as | 6900 | 9/19/2007 |
| | | | 16:03 |
| 105. | flash\as\com\xfactorstudio\xml\xpath\XPath2Functions.as | 7540 | 9/19/2007 |
| | | | 16:03 |
| 106. | flash\as\com\xfactorstudio\xml\xpath\XPathAxes.as | 13680 | 9/19/2007 |
| | | | 16:03 |
| 107. | flash\as\com\xfactorstudio\xml\xpath\XPathAxisNames.as | 2690 | 9/19/2007 |
| | | | 16:03 |
| 108. | flash\as\com\xfactorstudio\xml\xpath\XPathFunctionNames.as | 1920 | 9/19/2007 |
| | | | 16:03 |
| 109. | flash\as\com\xfactorstudio\xml\xpath\XPathFunctions.as | 10850 | 9/19/2007 |
| | | | 16:03 |
| 110. | flash\as\com\xfactorstudio\xml\xpath\XPathLexer.as | 7480 | 9/19/2007 |
| | | | 16:03 |
| 111. | flash\as\com\xfactorstudio\xml\xpath\XPathPredicateOperator.as | 2230 | 9/19/2007 |
| | | | 16:03 |
| 112. | flash\as\com\xfactorstudio\xml\xpath\XPathUtils.as | 2660 | 9/19/2007 |
| | | | 16:03 |
| 113. | flash\fla\applications\radar.fla | 40500 | 9/19/2007 |
| | | | 16:03 |
| 114. | flash\fla\applications\radarUI.fla | 40500 | 9/19/2007 |
| | | | 16:03 |
| 115. | flash\fla\applications\vssver2.scc | 120 | 9/20/2007 |
| | | | 10:54 |
| 116. | flash\fla\assets\assets.fla | 40000 | 9/19/2007 |
| | | | 16:03 |
| 117. | flash\fla\assets\langs\en-us.fla | 22000 | 9/19/2007 |
| | | | 16:03 |
| 118. | flash\fla\assets\langs\vssver2.scc | 90 | 9/20/2007 |
| | | | 10:54 |
| 119. | flash\fla\assets\SLTest.fla | 21000 | 9/19/2007 |
| | | | 16:03 |
| 120. | flash\fla\assets\vssver2.scc | 120 | 9/20/2007 |
| | | | 10:54 |
| 121. | flash\fla\consoles\device.fla | 1059000 | 9/19/2007 |
| | | | 16:03 |
| 122. | flash\fla\consoles\menu.fla | 492000 | 9/19/2007 |
| | | | 16:03 |
| 123. | flash\fla\consoles\notification.fla | 442000 | 9/19/2007 |
| | | | 16:03 |
| 124. | flash\fla\consoles\splash.fla | 42500 | 9/19/2007 |
| | | | 16:03 |
| 125. | flash\fla\consoles\vssver2.scc | 170 | 9/20/2007 |
| | | | 10:54 |
| 126. | flash\fla\effects\feedLoading.fla | 58000 | 9/19/2007 |
| | | | 16:03 |
| 127. | flash\fla\effects\radarStartupVideo.fla | 47000 | 9/19/2007 |
| | | | 16:03 |
| 128. | flash\fla\effects\thumbLoading.fla | 43000 | 9/19/2007 |
| | | | 16:03 |
| 129. | flash\fla\effects\vssver2.scc | 170 | 9/20/2007 |
| | | | 10:54 |
| 130. | flash\fla\sdk\radarAPI.fla | 66000 | 9/19/2007 |
| | | | 16:03 |
| 131. | flash\fla\sdk\vssver2.scc | 90 | 9/20/2007 |
| | | | 10:54 |
| 132. | flash\fla\skins\hydrogen\deviceSkin.fla | 1518500 | 9/20/2007 |
| | | | 13:24 |
| 133. | flash\fla\skins\hydrogen\deviceSkin3.fla | 1680500 | 9/19/2007 |
| | | | 19:58 |
| 134. | flash\fla\skins\hydrogen\deviceSkin-temp.fla | 1966000 | 9/19/2007 |
| | | | 22:26 |
| 135. | flash\fla\skins\hydrogen\vssver2.scc | 100 | 9/20/2007 |
| | | | 13:25 |
| 136. | flash\icons\iconMaster.psd | 35270 | 9/19/2007 |
| | | | 16:03 |
| 137. | flash\icons\radar.ico | 327190 | 9/19/2007 |
| | | | 16:03 |
| 138. | flash\icons\radar2.bmp | 9240 | 9/19/2007 |
| | | | 16:03 |
| 139. | flash\icons\vssver2.scc | 140 | 9/20/2007 |
| | | | 10:54 |
| 140. | flash\Radar.flp | 12510 | 9/19/2007 |
| | | | 16:03 |
| 141. | flash\radar.mproj | 2510 | 9/19/2007 |
| | | | 16:03 |
| 142. | flash\radarUI.mproj | 2510 | 9/19/2007 |
| | | | 16:03 |
| 143. | flash\swf\browser\activeItem.html | 12030 | 9/19/2007 |
| | | | 23:13 |
| 144. | flash\swf\browser\back.jpg | 440 | 9/19/2007 |
| | | | 16:03 |
| 145. | flash\swf\browser\back_over.jpg | 560 | 9/19/2007 |
| | | | 16:03 |
| 146. | flash\swf\browser\forward.jpg | 430 | 9/19/2007 |
| | | | 16:03 |
| 147. | flash\swf\browser\forward_over.jpg | 540 | 9/19/2007 |
| | | | 16:03 |
| 148. | flash\swf\browser\go.jpg | 420 | 9/19/2007 |
| | | | 16:03 |
| 149. | flash\swf\browser\go_over.jpg | 550 | 9/19/2007 |
| | | | 16:03 |
| 150. | flash\swf\browser\home.jpg | 590 | 9/19/2007 |
| | | | 16:03 |
| 151. | flash\swf\browser\home_over.jpg | 670 | 9/19/2007 |
| | | | 16:03 |
| 152. | flash\swf\browser\logo.jpg | 620 | 9/19/2007 |
| | | | 16:03 |
| 153. | flash\swf\browser\logo_over.jpg | 710 | 9/19/2007 |
| | | | 16:03 |
| 154. | flash\swf\browser\radar.html | 12040 | 9/19/2007 |
| | | | 16:03 |
| 155. | flash\swf\browser\search.jpg | 610 | 9/19/2007 |
| | | | 16:03 |
| 156. | flash\swf\browser\search_over.jpg | 660 | 9/19/2007 |
| | | | 16:03 |
| 157. | flash\swf\browser\vssver2.scc | 420 | 9/20/2007 |
| | | | 10:54 |
| 158. | flash\swf\data\bliptv.js | 350 | 9/19/2007 |
| | | | 16:03 |
| 159. | flash\swf\data\break.js | 1640 | 9/19/2007 |
| | | | 16:03 |
| 160. | flash\swf\data\crave.js | 780 | 9/19/2007 |
| | | | 16:03 |
| 161. | flash\swf\data\dailymotion.js | 540 | 9/19/2007 |
| | | | 16:03 |
| 162. | flash\swf\data\earthshots.js | 330 | 9/19/2007 |
| | | | 16:03 |
| 163. | flash\swf\data\favorites.xml | 11840 | 9/20/2007 |
| | | | 13:39 |
| 164. | flash\swf\data\google.js | 3420 | 9/19/2007 |
| | | | 16:03 |
| 165. | flash\swf\data\jumpcut.js | 750 | 9/19/2007 |
| | | | 16:03 |
| 166. | flash\swf\data\radar.js | 710 | 9/19/2007 |
| | | | 16:03 |
| 167. | flash\swf\data\Radar.xml | 32100 | 9/20/2007 |
| | | | 10:54 |
| 168. | flash\swf\data\reuters.js | 490 | 9/19/2007 |
| | | | 16:03 |
| 169. | flash\swf\data\settings.xml | 1220 | 9/20/2007 |
| | | | 10:54 |
| 170. | flash\swf\data\space.js | 1250 | 9/19/2007 |
| | | | 16:03 |
| 171. | flash\swf\data\time.js | 830 | 9/19/2007 |
| | | | 16:03 |
| 172. | flash\swf\data\ubcbotany.js | 320 | 9/19/2007 |
| | | | 16:03 |
| 173. | flash\swf\data\view.html | 930 | 9/20/2007 |
| | | | 12:02 |
| 174. | flash\swf\data\vssver2.scc | 540 | 9/20/2007 |
| | | | 10:54 |
| 175. | flash\swf\data\webshots.js | 690 | 9/19/2007 |
| | | | 16:03 |
| 176. | flash\swf\data\yahooblog.js | 990 | 9/19/2007 |
| | | | 16:03 |
| 177. | flash\swf\data\yahoophoto.js | 540 | 9/19/2007 |
| | | | 16:03 |
| 178. | flash\swf\data\youtube.js | 1500 | 9/19/2007 |
| | | | 16:03 |
| 179. | flash\swf\device.swf | 52260 | 9/20/2007 |
| | | | 12:02 |
| 180. | flash\swf\EULA.rtf | 46170 | 9/19/2007 |
| | | | 16:03 |
| 181. | flash\swf\feedLoading.swf | 2630 | 9/20/2007 |
| | | | 10:55 |
| 182. | flash\swf\Radar.exe | 1743740 | 9/20/2007 |
| | | | 10:56 |
| 183. | flash\swf\radar.swf | 6900 | 9/20/2007 |
| | | | 10:55 |
| 184. | flash\swf\radarAPI.swf | 1250 | 9/20/2007 |
| | | | 10:55 |
| 185. | flash\swf\radarStartupVideo.flv | 23490 | 9/19/2007 |
| | | | 16:03 |
| 186. | flash\swf\RadarUI.exe | 1773000 | 9/20/2007 |
| | | | 10:56 |
| 187. | flash\swf\radarUI.swf | 36140 | 9/20/2007 |
| | | | 10:55 |
| 188. | flash\swf\skins\hydrogen\accesshollywood.png | 3720 | 9/19/2007 |
| | | | 16:03 |
| 189. | flash\swf\skins\hydrogen\Animation.png | 5950 | 9/19/2007 |
| | | | 16:03 |
| 190. | flash\swf\skins\hydrogen\apple.png | 2880 | 9/19/2007 |
| | | | 16:03 |
| 191. | flash\swf\skins\hydrogen\apple_small.png | 700 | 9/19/2007 |
| | | | 16:03 |
| 192. | flash\swf\skins\hydrogen\Archive.png | 4200 | 9/19/2007 |
| | | | 16:03 |
| 193. | flash\swf\skins\hydrogen\Audio.png | 8100 | 9/19/2007 |
| | | | 16:03 |
| 194. | flash\swf\skins\hydrogen\autoblog.png | 3100 | 9/19/2007 |
| | | | 16:03 |
| 195. | flash\swf\skins\hydrogen\autoblog_large.png | 12900 | 9/19/2007 |
| | | | 16:03 |
| 196. | flash\swf\skins\hydrogen\bbc.png | 2580 | 9/19/2007 |
| | | | 16:03 |
| 197. | flash\swf\skins\hydrogen\bbc_small.png | 1360 | 9/19/2007 |
| | | | 16:03 |
| 198. | flash\swf\skins\hydrogen\bebo.png | 1750 | 9/19/2007 |
| | | | 16:03 |
| 199. | flash\swf\skins\hydrogen\blackplanet.png | 1400 | 9/19/2007 |
| | | | 16:03 |
| 200. | flash\swf\skins\hydrogen\blendtec.png | 3960 | 9/19/2007 |
| | | | 16:03 |
| 201. | flash\swf\skins\hydrogen\bliptv.png | 3390 | 9/19/2007 |
| | | | 16:03 |
| 202. | flash\swf\skins\hydrogen\bliptv_small.png | 1450 | 9/19/2007 |
| | | | 16:03 |
| 203. | flash\swf\skins\hydrogen\blogs.png | 5100 | 9/19/2007 |
| | | | 16:03 |
| 204. | flash\swf\skins\hydrogen\boingboing.png | 1300 | 9/19/2007 |
| | | | 16:03 |
| 205. | flash\swf\skins\hydrogen\boingboing_large.png | 3160 | 9/19/2007 |
| | | | 16:03 |
| 206. | flash\swf\skins\hydrogen\break.png | 4060 | 9/19/2007 |
| | | | 16:03 |
| 207. | flash\swf\skins\hydrogen\break_small.png | 1600 | 9/19/2007 |
| | | | 16:03 |
| 208. | flash\swf\skins\hydrogen\Business.png | 6230 | 9/19/2007 |
| | | | 16:03 |
| 209. | flash\swf\skins\hydrogen\businesses.png | 4410 | 9/19/2007 |
| | | | 16:03 |
| 210. | flash\swf\skins\hydrogen\cbs.png | 3190 | 9/19/2007 |
| | | | 16:03 |
| 211. | flash\swf\skins\hydrogen\cbs_small.png | 2100 | 9/19/2007 |
| | | | 16:03 |
| 212. | flash\swf\skins\hydrogen\cinematical.png | 2690 | 9/19/2007 |
| | | | 16:03 |
| 213. | flash\swf\skins\hydrogen\cinematical_large.png | 11160 | 9/19/2007 |
| | | | 16:03 |
| 214. | flash\swf\skins\hydrogen\classmates.png | 4570 | 9/19/2007 |
| | | | 16:03 |
| 215. | flash\swf\skins\hydrogen\comedy.png | 5150 | 9/19/2007 |
| | | | 16:03 |
| 216. | flash\swf\skins\hydrogen\community.png | 4510 | 9/19/2007 |
| | | | 16:03 |
| 217. | flash\swf\skins\hydrogen\crave.png | 4350 | 9/19/2007 |
| | | | 16:03 |
| 218. | flash\swf\skins\hydrogen\crave_large.png | 10690 | 9/19/2007 |
| | | | 16:03 |
| 219. | flash\swf\skins\hydrogen\current.png | 2440 | 9/19/2007 |
| | | | 16:03 |
| 220. | flash\swf\skins\hydrogen\dailymotion.png | 3510 | 9/19/2007 |
| | | | 16:03 |
| 221. | flash\swf\skins\hydrogen\dailymotion_small.png | 1600 | 9/19/2007 |
| | | | 16:03 |
| 222. | flash\swf\skins\hydrogen\deviceSkin.swf | 202830 | 9/20/2007 |
| | | | 10:55 |
| 223. | flash\swf\skins\hydrogen\downloadsquad.png | 2210 | 9/19/2007 |
| | | | 16:03 |
| 224. | flash\swf\skins\hydrogen\downloadsquad_large.png | 6380 | 9/19/2007 |
| | | | 16:03 |
| 225. | flash\swf\skins\hydrogen\earthshots.png | 3540 | 9/19/2007 |
| | | | 16:03 |
| 226. | flash\swf\skins\hydrogen\ebaum.png | 6900 | 9/19/2007 |
| | | | 16:03 |
| 227. | flash\swf\skins\hydrogen\ebaum_small.png | 2260 | 9/19/2007 |
| | | | 16:03 |
| 228. | flash\swf\skins\hydrogen\EditorPicks.png | 7880 | 9/19/2007 |
| | | | 16:03 |
| 229. | flash\swf\skins\hydrogen\Education.png | 6040 | 9/19/2007 |
| | | | 16:03 |
| 230. | flash\swf\skins\hydrogen\engadget.png | 2710 | 9/19/2007 |
| | | | 16:03 |
| 231. | flash\swf\skins\hydrogen\engadget_large.png | 5210 | 9/19/2007 |
| | | | 16:03 |
| 232. | flash\swf\skins\hydrogen\Entertainment.png | 7120 | 9/19/2007 |
| | | | 16:03 |
| 233. | flash\swf\skins\hydrogen\Environment.png | 3790 | 9/19/2007 |
| | | | 16:03 |
| 234. | flash\swf\skins\hydrogen\eutube.png | 1820 | 9/19/2007 |
| | | | 16:03 |
| 235. | flash\swf\skins\hydrogen\extra.png | 9540 | 9/19/2007 |
| | | | 16:03 |
| 236. | flash\swf\skins\hydrogen\extraFeatured.png | 5000 | 9/19/2007 |
| | | | 16:03 |
| 237. | flash\swf\skins\hydrogen\facebook.png | 1750 | 9/19/2007 |
| | | | 16:03 |
| 238. | flash\swf\skins\hydrogen\Fashion.png | 8120 | 9/19/2007 |
| | | | 16:03 |
| 239. | flash\swf\skins\hydrogen\favorites.png | 2950 | 9/19/2007 |
| | | | 16:03 |
| 240. | flash\swf\skins\hydrogen\featured.png | 9540 | 9/19/2007 |
| | | | 16:03 |
| 241. | flash\swf\skins\hydrogen\flixster.png | 2580 | 9/19/2007 |
| | | | 16:03 |
| 242. | flash\swf\skins\hydrogen\fordmodels.png | 2230 | 9/19/2007 |
| | | | 16:03 |
| 243. | flash\swf\skins\hydrogen\fotothing.png | 2790 | 9/19/2007 |
| | | | 16:03 |
| 244. | flash\swf\skins\hydrogen\fotothing_small.png | 3040 | 9/19/2007 |
| | | | 16:03 |
| 245. | flash\swf\skins\hydrogen\foxnews.png | 3780 | 9/19/2007 |
| | | | 16:03 |
| 246. | flash\swf\skins\hydrogen\foxnews_small.png | 1880 | 9/19/2007 |
| | | | 16:03 |
| 247. | flash\swf\skins\hydrogen\friendster.png | 2300 | 9/19/2007 |
| | | | 16:03 |
| 248. | flash\swf\skins\hydrogen\g4tv.png | 2780 | 9/19/2007 |
| | | | 16:03 |
| 249. | flash\swf\skins\hydrogen\gadling.png | 4040 | 9/19/2007 |
| | | | 16:03 |
| 250. | flash\swf\skins\hydrogen\gadling_large.png | 10900 | 9/19/2007 |
| | | | 16:03 |
| 251. | flash\swf\skins\hydrogen\gaia.png | 3130 | 9/19/2007 |
| | | | 16:03 |
| 252. | flash\swf\skins\hydrogen\gametrailers.png | 4690 | 9/19/2007 |
| | | | 16:03 |
| 253. | flash\swf\skins\hydrogen\google.png | 4730 | 9/19/2007 |
| | | | 16:03 |
| 254. | flash\swf\skins\hydrogen\google_small.png | 1910 | 9/19/2007 |
| | | | 16:03 |
| 255. | flash\swf\skins\hydrogen\google_sports.png | 5150 | 9/19/2007 |
| | | | 16:03 |
| 256. | flash\swf\skins\hydrogen\grouper.png | 3710 | 9/19/2007 |
| | | | 16:03 |
| 257. | flash\swf\skins\hydrogen\grouper_small.png | 820 | 9/19/2007 |
| | | | 16:03 |
| 258. | flash\swf\skins\hydrogen\grouper_sports.png | 2170 | 9/19/2007 |
| | | | 16:03 |
| 259. | flash\swf\skins\hydrogen\heavy.png | 5090 | 9/19/2007 |
| | | | 16:03 |
| 260. | flash\swf\skins\hydrogen\heavy_small.png | 1700 | 9/19/2007 |
| | | | 16:03 |
| 261. | flash\swf\skins\hydrogen\hi5.png | 2450 | 9/19/2007 |
| | | | 16:03 |
| 262. | flash\swf\skins\hydrogen\Hollywood.png | 6430 | 9/19/2007 |
| | | | 16:03 |
| 263. | flash\swf\skins\hydrogen\ifilm.png | 2010 | 9/19/2007 |
| | | | 16:03 |
| 264. | flash\swf\skins\hydrogen\ifilm_small.png | 1020 | 9/19/2007 |
| | | | 16:03 |
| 265. | flash\swf\skins\hydrogen\imagestation.png | 2550 | 9/19/2007 |
| | | | 16:03 |
| 266. | flash\swf\skins\hydrogen\imeem.png | 3790 | 9/19/2007 |
| | | | 16:03 |
| 267. | flash\swf\skins\hydrogen\InDepth.png | 5350 | 9/19/2007 |
| | | | 16:03 |
| 268. | flash\swf\skins\hydrogen\joystiq.png | 2360 | 9/19/2007 |
| | | | 16:03 |
| 269. | flash\swf\skins\hydrogen\joystiq_large.png | 7510 | 9/19/2007 |
| | | | 16:03 |
| 270. | flash\swf\skins\hydrogen\jumpcut.png | 1970 | 9/19/2007 |
| | | | 16:03 |
| 271. | flash\swf\skins\hydrogen\jumpcut_small.png | 1490 | 9/19/2007 |
| | | | 16:03 |
| 272. | flash\swf\skins\hydrogen\Latest.png | 5840 | 9/19/2007 |
| | | | 16:03 |
| 273. | flash\swf\skins\hydrogen\linkedin.png | 2340 | 9/19/2007 |
| | | | 16:03 |
| 274. | flash\swf\skins\hydrogen\livejournal.png | 2760 | 9/19/2007 |
| | | | 16:03 |
| 275. | flash\swf\skins\hydrogen\livescience.png | 1880 | 9/19/2007 |
| | | | 16:03 |
| 276. | flash\swf\skins\hydrogen\livespaces.png | 2640 | 9/19/2007 |
| | | | 16:03 |
| 277. | flash\swf\skins\hydrogen\In.png | 3400 | 9/19/2007 |
| | | | 16:03 |
| 278. | flash\swf\skins\hydrogen\maninabox.png | 3160 | 9/19/2007 |
| | | | 16:03 |
| 279. | flash\swf\skins\hydrogen\mashable.png | 3290 | 9/19/2007 |
| | | | 16:03 |
| 280. | flash\swf\skins\hydrogen\mashable_large.png | 11930 | 9/19/2007 |
| | | | 16:03 |
| 281. | flash\swf\skins\hydrogen\metacafe.png | 2380 | 9/19/2007 |
| | | | 16:03 |
| 282. | flash\swf\skins\hydrogen\metacafe_small.png | 1460 | 9/19/2007 |
| | | | 16:03 |
| 283. | flash\swf\skins\hydrogen\moreTopics.png | 5700 | 9/19/2007 |
| | | | 16:03 |
| 284. | flash\swf\skins\hydrogen\MostDiscussed.png | 8210 | 9/19/2007 |
| | | | 16:03 |
| 285. | flash\swf\skins\hydrogen\MostDiscussedThisMonth.png | 6920 | 9/19/2007 |
| | | | 16:03 |
| 286. | flash\swf\skins\hydrogen\MostDiscussedThisWeek.png | 6950 | 9/19/2007 |
| | | | 16:03 |
| 287. | flash\swf\skins\hydrogen\MostDiscussedToday.png | 6950 | 9/19/2007 |
| | | | 16:03 |
| 288. | flash\swf\skins\hydrogen\MostViewedAllTime.png | 6190 | 9/19/2007 |
| | | | 16:03 |
| 289. | flash\swf\skins\hydrogen\MostViewedThisMonth.png | 6480 | 9/19/2007 |
| | | | 16:03 |
| 290. | flash\swf\skins\hydrogen\MostViewedThisWeek.png | 6500 | 9/19/2007 |
| | | | 16:03 |
| 291. | flash\swf\skins\hydrogen\MostViewedToday.png | 6510 | 9/19/2007 |
| | | | 16:04 |
| 292. | flash\swf\skins\hydrogen\Movies.png | 7430 | 9/19/2007 |
| | | | 16:04 |
| 293. | flash\swf\skins\hydrogen\music.png | 5810 | 9/19/2007 |
| | | | 16:04 |
| 294. | flash\swf\skins\hydrogen\myspace.png | 3890 | 9/19/2007 |
| | | | 16:04 |
| 295. | flash\swf\skins\hydrogen\myyearbook.png | 3660 | 9/19/2007 |
| | | | 16:04 |
| 296. | flash\swf\skins\hydrogen\nationalgeographic.png | 940 | 9/19/2007 |
| | | | 16:04 |
| 297. | flash\swf\skins\hydrogen\nba.png | 3220 | 9/19/2007 |
| | | | 16:04 |
| 298. | flash\swf\skins\hydrogen\nba_small.png | 910 | 9/19/2007 |
| | | | 16:04 |
| 299. | flash\swf\skins\hydrogen\nba_sports.png | 3070 | 9/19/2007 |
| | | | 16:04 |
| 300. | flash\swf\skins\hydrogen\nbc.png | 2830 | 9/19/2007 |
| | | | 16:04 |
| 301. | flash\swf\skins\hydrogen\nbc_small.png | 1330 | 9/19/2007 |
| | | | 16:04 |
| 302. | flash\swf\skins\hydrogen\netlog.png | 1790 | 9/19/2007 |
| | | | 16:04 |
| 303. | flash\swf\skins\hydrogen\news.png | 7120 | 9/19/2007 |
| | | | 16:04 |
| 304. | flash\swf\skins\hydrogen\ning.png | 3020 | 9/19/2007 |
| | | | 16:04 |
| 305. | flash\swf\skins\hydrogen\OddlyEnough.png | 6180 | 9/19/2007 |
| | | | 16:04 |
| 306. | flash\swf\skins\hydrogen\organizations.png | 4820 | 9/19/2007 |
| | | | 16:04 |
| 307. | flash\swf\skins\hydrogen\orkut.png | 1860 | 9/19/2007 |
| | | | 16:04 |
| 308. | flash\swf\skins\hydrogen\pbs.png | 3000 | 9/19/2007 |
| | | | 16:04 |
| 309. | flash\swf\skins\hydrogen\pbs_small.png | 1080 | 9/19/2007 |
| | | | 16:04 |
| 310. | flash\swf\skins\hydrogen\Pets.png | 6250 | 9/19/2007 |
| | | | 16:04 |
| 311. | flash\swf\skins\hydrogen\photobucket.png | 2060 | 9/19/2007 |
| | | | 16:04 |
| 312. | flash\swf\skins\hydrogen\photobucket_small.png | 470 | 9/19/2007 |
| | | | 16:04 |
| 313. | flash\swf\skins\hydrogen\photobucket_sports.png | 2160 | 9/19/2007 |
| | | | 16:04 |
| 314. | flash\swf\skins\hydrogen\photos.png | 5750 | 9/19/2007 |
| | | | 16:04 |
| 315. | flash\swf\skins\hydrogen\piczo.png | 2570 | 9/19/2007 |
| | | | 16:04 |
| 316. | flash\swf\skins\hydrogen\politics.png | 8080 | 9/19/2007 |
| | | | 16:04 |
| 317. | flash\swf\skins\hydrogen\radar_hd.png | 4030 | 9/19/2007 |
| | | | 16:04 |
| 318. | flash\swf\skins\hydrogen\radar_hd_small.png | 2020 | 9/19/2007 |
| | | | 16:04 |
| 319. | flash\swf\skins\hydrogen\radarDefault.png | 4510 | 9/19/2007 |
| | | | 16:04 |
| 320. | flash\swf\skins\hydrogen\RecentlyAdded.png | 6500 | 9/19/2007 |
| | | | 16:04 |
| 321. | flash\swf\skins\hydrogen\RecentlyFeatured.png | 6500 | 9/19/2007 |
| | | | 16:04 |
| 322. | flash\swf\skins\hydrogen\reuters.png | 2420 | 9/19/2007 |
| | | | 16:04 |
| 323. | flash\swf\skins\hydrogen\reuters_small.png | 860 | 9/19/2007 |
| | | | 16:04 |
| 324. | flash\swf\skins\hydrogen\reuters_sports.png | 2050 | 9/19/2007 |
| | | | 16:04 |
| 325. | flash\swf\skins\hydrogen\ringo.png | 2560 | 9/19/2007 |
| | | | 16:04 |
| 326. | flash\swf\skins\hydrogen\search.png | 3840 | 9/19/2007 |
| | | | 16:04 |
| 327. | flash\swf\skins\hydrogen\search_small.png | 4530 | 9/19/2007 |
| | | | 16:04 |
| 328. | flash\swf\skins\hydrogen\settings.png | 4340 | 9/19/2007 |
| | | | 16:04 |
| 329. | flash\swf\skins\hydrogen\sevenload.png | 2990 | 9/19/2007 |
| | | | 16:04 |
| 330. | flash\swf\skins\hydrogen\showbiz.png | 6890 | 9/19/2007 |
| | | | 16:04 |
| 331. | flash\swf\skins\hydrogen\smosh.png | 2620 | 9/19/2007 |
| | | | 16:04 |
| 332. | flash\swf\skins\hydrogen\social.png | 8960 | 9/19/2007 |
| | | | 16:04 |
| 333. | flash\swf\skins\hydrogen\space.png | 1670 | 9/19/2007 |
| | | | 16:04 |
| 334. | flash\swf\skins\hydrogen\spiked.png | 3470 | 9/19/2007 |
| | | | 16:04 |
| 335. | flash\swf\skins\hydrogen\spiked_small.png | 4810 | 9/19/2007 |
| | | | 16:04 |
| 336. | flash\swf\skins\hydrogen\sports.png | 4810 | 9/19/2007 |
| | | | 16:04 |
| 337. | flash\swf\skins\hydrogen\tagged.png | 2220 | 9/19/2007 |
| | | | 16:04 |
| 338. | flash\swf\skins\hydrogen\techcrunch.png | 760 | 9/19/2007 |
| | | | 16:04 |
| 339. | flash\swf\skins\hydrogen\techcrunch_large.png | 7040 | 9/19/2007 |
| | | | 16:04 |
| 340. | flash\swf\skins\hydrogen\Technology.png | 5580 | 9/19/2007 |
| | | | 16:04 |
| 341. | flash\swf\skins\hydrogen\thehill88.png | 6160 | 9/19/2007 |
| | | | 16:04 |
| 342. | flash\swf\skins\hydrogen\time.png | 2580 | 9/19/2007 |
| | | | 16:04 |
| 343. | flash\swf\skins\hydrogen\tnawrestling.png | 3590 | 9/19/2007 |
| | | | 16:04 |
| 344. | flash\swf\skins\hydrogen\TopFavorites.png | 4940 | 9/19/2007 |
| | | | 16:04 |
| 345. | flash\swf\skins\hydrogen\TopRated.png | 4440 | 9/19/2007 |
| | | | 16:04 |
| 346. | flash\swf\skins\hydrogen\TopRatedThisMonth.png | 5380 | 9/19/2007 |
| | | | 16:04 |
| 347. | flash\swf\skins\hydrogen\TopRatedThisWeek.png | 5380 | 9/19/2007 |
| | | | 16:04 |
| 348. | flash\swf\skins\hydrogen\TopRatedToday.png | 5400 | 9/19/2007 |
| | | | 16:04 |
| 349. | flash\swf\skins\hydrogen\Travel.png | 6980 | 9/19/2007 |
| | | | 16:04 |
| 350. | flash\swf\skins\hydrogen\tribe.png | 3070 | 9/19/2007 |
| | | | 16:04 |
| 351. | flash\swf\skins\hydrogen\TV.png | 7120 | 9/19/2007 |
| | | | 16:04 |
| 352. | flash\swf\skins\hydrogen\tvsquad.png | 3830 | 9/19/2007 |
| | | | 16:04 |
| 353. | flash\swf\skins\hydrogen\tvsquad_large.png | 10540 | 9/19/2007 |
| | | | 16:04 |
| 354. | flash\swf\skins\hydrogen\ubcbotany.png | 2670 | 9/19/2007 |
| | | | 16:04 |
| 355. | flash\swf\skins\hydrogen\universalmusicgroup.png | 3480 | 9/19/2007 |
| | | | 16:04 |
| 356. | flash\swf\skins\hydrogen\VideoGames.png | 7270 | 9/19/2007 |
| | | | 16:04 |
| 357. | flash\swf\skins\hydrogen\videos.png | 4570 | 9/19/2007 |
| | | | 16:04 |
| 358. | flash\swf\skins\hydrogen\vssver2.scc | 5380 | 9/20/2007 |
| | | | 10:54 |
| 359. | flash\swf\skins\hydrogen\wayn.png | 3690 | 9/19/2007 |
| | | | 16:04 |
| 360. | flash\swf\skins\hydrogen\webshots.png | 3020 | 9/19/2007 |
| | | | 16:04 |
| 361. | flash\swf\skins\hydrogen\xanga.png | 2000 | 9/19/2007 |
| | | | 16:04 |
| 362. | flash\swf\skins\hydrogen\y360.png | 1770 | 9/19/2007 |
| | | | 16:04 |
| 363. | flash\swf\skins\hydrogen\yahoo_sports.png | 3450 | 9/19/2007 |
| | | | 16:04 |
| 364. | flash\swf\skins\hydrogen\yahoonews.png | 3410 | 9/19/2007 |
| | | | 16:04 |
| 365. | flash\swf\skins\hydrogen\yahoonews_large.png | 5930 | 9/19/2007 |
| | | | 16:04 |
| 366. | flash\swf\skins\hydrogen\youtube.png | 2560 | 9/19/2007 |
| | | | 16:04 |
| 367. | flash\swf\skins\hydrogen\youtube_small.png | 1330 | 9/19/2007 |
| | | | 16:04 |
| 368. | flash\swf\thumbLoading.swf | 1290 | 9/20/2007 |
| | | | 10:55 |
| 369. | flash\swf\version.xml | 110 | 9/19/2007 |
| | | | 16:03 |
| 370. | flash\swf\vssver2.scc | 150 | 9/20/2007 |
| | | | 10:54 |
| 371. | flash\vssver2.scc | 130 | 9/20/2007 |
| | | | 10:54 |
| 372. | installer\Setup\banner.jpg | 21590 | 9/19/2007 |
| | | | 16:04 |
| 373. | installer\Setup\mssccprj.scc | 160 | 9/20/2007 |
| | | | 10:54 |
| 374. | installer\Setup\Setup.sln | 850 | 9/19/2007 |
| | | | 16:04 |
| 375. | installer\Setup\Setup\mssccprj.scc | 170 | 9/20/2007 |
| | | | 10:54 |
| 376. | installer\Setup\Setup\Setup.vdproj | 226240 | 9/19/2007 |
| | | | 16:04 |
| 377. | installer\Setup\Setup\vssver2.scc | 100 | 9/20/2007 |
| | | | 10:54 |
| 378. | installer\Setup\vssver2.scc | 110 | 9/20/2007 |
| | | | 10:54 |
| 379. | legacy\javascript\aintitcool.js | 780 | 9/20/2007 |
| | | | 10:54 |
| 380. | legacy\javascript\apple_init.js | 440 | 9/20/2007 |
| | | | 10:54 |
| 381. | legacy\javascript\bliptv_init.js | 520 | 9/20/2007 |
| | | | 10:54 |
| 382. | legacy\javascript\break_init.js | 420 | 9/20/2007 |
| | | | 10:54 |
| 383. | legacy\javascript\dailymotion_init.js | 720 | 9/20/2007 |
| | | | 10:54 |
| 384. | legacy\javascript\ebaum.js | 490 | 9/20/2007 |
| | | | 10:54 |
| 385. | legacy\javascript\google_init.js | 2010 | 9/20/2007 |
| | | | 10:54 |
| 386. | legacy\javascript\grouper.js | 460 | 9/20/2007 |
| | | | 10:54 |
| 387. | legacy\javascript\grouper_init.js | 5010 | 9/20/2007 |
| | | | 10:54 |
| 388. | legacy\javascript\heavy.js | 660 | 9/20/2007 |
| | | | 10:54 |
| 389. | legacy\javascript\heavy_init.js | 1560 | 9/20/2007 |
| | | | 10:54 |
| 390. | legacy\javascript\ifilm.js | 750 | 9/20/2007 |
| | | | 10:54 |
| 391. | legacy\javascript\ifilm_init.js | 620 | 9/20/2007 |
| | | | 10:54 |
| 392. | legacy\javascript\metacafe.js | 800 | 9/20/2007 |
| | | | 10:54 |
| 393. | legacy\javascript\metacafe_init.js | 570 | 9/20/2007 |
| | | | 10:54 |
| 394. | legacy\javascript\nba.js | 1260 | 9/20/2007 |
| | | | 10:54 |
| 395. | legacy\javascript\nba_init.js | 820 | 9/20/2007 |
| | | | 10:54 |
| 396. | legacy\javascript\reuters_feed.js | 610 | 9/20/2007 |
| | | | 10:54 |
| 397. | legacy\javascript\reuters_init.js | 1380 | 9/20/2007 |
| | | | 10:54 |
| 398. | legacy\javascript\vssver2.scc | 670 | 9/20/2007 |
| | | | 10:54 |
| 399. | legacy\javascript\youtube_feed.js | 780 | 9/20/2007 |
| | | | 10:54 |
| 400. | legacy\javascript\youtube_init.js | 2130 | 9/20/2007 |
| | | | 10:54 |
| 401. | native\ActiveXBlip\_Blip.h | 12410 | 9/19/2007 |
| | | | 16:10 |
| 402. | native\ActiveXBlip\_Blip.idl | 2010 | 9/19/2007 |
| | | | 16:10 |
| 403. | native\ActiveXBlip\_Blip.tlb | 2370 | 9/19/2007 |
| | | | 16:10 |
| 404. | native\ActiveXBlip\_Blip_i.c | 1990 | 9/19/2007 |
| | | | 16:10 |
| 405. | native\ActiveXBlip\_Blip_p.c | 13370 | 9/19/2007 |
| | | | 16:10 |
| 406. | native\ActiveXBlip\Blip.cpp | 450 | 9/19/2007 |
| | | | 16:04 |
| 407. | native\ActiveXBlip\Blip.ncb | 11395000 | 9/19/2007 |
| | | | 16:10 |
| 408. | native\ActiveXBlip\Blip.rc | 2790 | 9/19/2007 |
| | | | 16:04 |
| 409. | native\ActiveXBlip\Blip.rgs | 110 | 9/19/2007 |
| | | | 16:04 |
| 410. | native\ActiveXBlip\Blip.sln | 1290 | 9/19/2007 |
| | | | 16:04 |
| 411. | native\ActiveXBlip\Blip.suo | 7500 | 9/19/2007 |
| | | | 16:10 |
| 412. | native\ActiveXBlip\Blip.vcproj | 6150 | 9/19/2007 |
| | | | 16:04 |
| 413. | native\ActiveXBlip\Blip.vcproj.LILRAMPY.Dale.user | 1360 | 9/19/2007 |
| | | | 16:10 |
| 414. | native\ActiveXBlip\Blipps.def | 190 | 9/19/2007 |
| | | | 16:04 |
| 415. | native\ActiveXBlip\BlipPS.vcproj | 3990 | 9/19/2007 |
| | | | 16:04 |
| 416. | native\ActiveXBlip\BlipPS.vcproj.LILRAMPY.Dale.user | 1360 | 9/19/2007 |
| | | | 16:10 |
| 417. | native\ActiveXBlip\BlipPS.vcproj.vspscc | 340 | 9/19/2007 |
| | | | 16:04 |
| 418. | native\ActiveXBlip\Debug\Blip.dll | 812000 | 9/19/2007 |
| | | | 16:04 |
| 419. | native\ActiveXBlip\Debug\vssver2.scc | 100 | 9/20/2007 |
| | | | 10:54 |
| 420. | native\ActiveXBlip\dlldata.c | 810 | 9/19/2007 |
| | | | 16:10 |
| 421. | native\ActiveXBlip\mssccprj.scc | 410 | 9/20/2007 |
| | | | 10:54 |
| 422. | native\ActiveXBlip\RadarBlip.bmp | 240 | 9/19/2007 |
| | | | 16:04 |
| 423. | native\ActiveXBlip\RadarBlip.cpp | 2600 | 9/19/2007 |
| | | | 16:04 |
| 424. | native\ActiveXBlip\RadarBlip.h | 3780 | 9/19/2007 |
| | | | 16:04 |
| 425. | native\ActiveXBlip\RadarBlip.htm | 590 | 9/19/2007 |
| | | | 16:04 |
| 426. | native\ActiveXBlip\ReadMe.txt | 2840 | 9/19/2007 |
| | | | 16:04 |
| 427. | native\ActiveXBlip\Release\Blip.dll | 168000 | 9/19/2007 |
| | | | 16:10 |
| 428. | native\ActiveXBlip\Release\Blip.dll.intermediate.manifest | 140 | 9/19/2007 |
| | | | 16:10 |
| 429. | native\ActiveXBlip\Release\Blip.exp | 1000 | 9/19/2007 |
| | | | 16:10 |
| 430. | native\ActiveXBlip\Release\Blip.lib | 1460 | 9/19/2007 |
| | | | 16:10 |
| 431. | native\ActiveXBlip\Release\Blip.obj | 193840 | 9/19/2007 |
| | | | 16:10 |
| 432. | native\ActiveXBlip\Release\Blip.pch | 18176000 | 9/19/2007 |
| | | | 16:10 |
| 433. | native\ActiveXBlip\Release\Blip.pdb | 2995000 | 9/19/2007 |
| | | | 16:10 |
| 434. | native\ActiveXBlip\Release\Blip.res | 1340 | 9/19/2007 |
| | | | 16:10 |
| 435. | native\ActiveXBlip\Release\BuildLog.htm | 14040 | 9/19/2007 |
| | | | 16:10 |
| 436. | native\ActiveXBlip\Release\mt.dep | 60 | 9/19/2007 |
| | | | 16:10 |
| 437. | native\ActiveXBlip\Release\RadarBlip.obj | 778390 | 9/19/2007 |
| | | | 16:10 |
| 438. | native\ActiveXBlip\Release\stdafx.obj | 345230 | 9/19/2007 |
| | | | 16:10 |
| 439. | native\ActiveXBlip\Release\vc80.idb | 339000 | 9/19/2007 |
| | | | 16:10 |
| 440. | native\ActiveXBlip\Release\vc80.pdb | 1516000 | 9/19/2007 |
| | | | 16:10 |
| 441. | native\ActiveXBlip\resource.h | 520 | 9/19/2007 |
| | | | 16:04 |
| 442. | native\ActiveXBlip\stdafx.cpp | 200 | 9/19/2007 |
| | | | 16:04 |
| 443. | native\ActiveXBlip\stdafx.h | 1510 | 9/19/2007 |
| | | | 16:04 |
| 444. | native\ActiveXBlip\vssver2.scc | 500 | 9/20/2007 |
| | | | 10:54 |

### FIELD OF THE INVENTION

The invention relates generally to methods, systems and devices for accessing different media and web services from a ubiquitous user interface over the Internet. More specifically, the invention relates to methods and systems for providing and managing aggregation of and access to music, movies, photographs, text, messages, account credentials, and various web interfaces from a ubiquitous user interface.

### BACKGROUND

Computer and Internet technologies are ever increasing in relevance and importance in our day to day lives. The advent of the computer has prompted the creation of new formats and avenues of communication. These communications may include, for example, digital forms of music, movies, photos, and text-based communications. More recently, related Internet technologies have been developed to allow both corporations and end-users to create and publish these forms of information for public dissemination.

The advent of these new forms of communication or media gives rise to a new set of problems. For each media type, the users will have to recognize varying file formats. For example, a movie file may come in an mpg, .mpeg, .asf or .avi file format. If the user wants to obtain music, they must recognize .mp3, .aac, .ogg, .wma and others. In addition, not only does a user have to contend with an increasing number of file types, they also have to maintain several programs in order to view the assorted media types. Thus, for each file format, users have to know which program to download and install in order to access the file. Maintaining several different programs also presents issues with efficient access to the various media types. The user will have to load the relevant program and navigate the program's user interface (UI) to get access to the content. Thus, the user will have to contend with a vast array of UI designs that in many cases differ greatly.

Many Internet users today maintain a plurality of devices capable of acquiring information or communicating using the Internet. For example, a user may use any combination of: home computing devices, mobile devices, or gaming devices that provide access to Internet content, for example Sony's® Playstation 3® or Microsoft's® Xbox 360®. Thus, a user may be required to solve the aforementioned problems for both a plurality of different media types, playback programs, and computing devices.

One popular method of accessing information available over the Internet has been through a web browser interface such as the Microsoft® Internet Explorer® browser or the Mozilla® Firefox® browser. These browsers attempt to provide a somewhat ubiquitous user interface via a somewhat standard method of access to information. The modern browser helps the user navigate through the Internet, providing search and view capabilities. Further, such browsers provide user access to websites that allow for access to various forms of media. For example, YouTube.com® allows a user to upload and locate home-generated media files, while sites like Flicker.com® and PhotoBucket.com® allow for end-user uploading and viewing of photographs.

Some browsers may function across multiple devices and platforms. Thus, an end-user might be able to utilize the browser interface on their home computer, their personal media device or their personal mobile device. For example, the Apple® Safari® browser can be used on personal computing devices or on mobile devices such as the iPod® Touch® or the iPhone®. Similarly, Internet Explorer may be used on Windows® XP® desktops and mobile devices running Windows® CE®.

However, while a user might be able to view the various forms of communication and media on a wide array of devices, they are not guaranteed the same viewing or access experience across all platforms. By using a browser interface, the user will still have to navigate each individual webpage design. Thus, while the browser may define a standard of access, each individual webpage will most likely have a unique way to present data. For example, a user may need to access a video content website such as YouTube.com® for a particular video that is freely available. To acquire pay content, a user may be need to visit another website that allows download of pay content, such as the recently available Netflix.com® movie download service. To acquire a blog or photos on the same topic, a user may be forced to visit several other websites in order to acquire the content they seek. To utilize chat or other direct Internet communications, a user must visit a website directed to the chat or other communication sought. To publish content on a social-networking site, a user must visit that site.

Thus, although web browsers improve the accessibility of information and venues of communication available over the Internet, users must contend with endlessly varying and possibly complex webpage interfaces in order to access that information. In addition, these browsers are not finely tuned to provide capabilities catered to a subset of the information available. Instead, existing web browsers are directed to improve a user's experience for all the content available over the Internet, thus reducing the efficiency and ease of use for specific data acquisition or communication Internet experiences.

In addition to having to locate and navigate these individual sites to gather and enjoy content or communicate, users may further be required to manage account information for each site they visit. Many content-providing websites require a user to maintain account information such as login information (username and password), notification options, associated email addresses, and so on. Because a typical Internet user utilizes a plethora of different websites to enjoy a variety of Internet experiences, users must maintain a seemingly endless number of accounts for an equally endless number of web pages.

One attempt to address the issue of a multiplicity of web page and accounts is to enable computer device operating systems such as Apple® OSX® and Microsoft® Windows®, and/or modern web browsers, to provide “keychains” or “coolies” that allow a user to define account information for specific websites so that when a website is visited in the web browser, the user need not login to his or her account with that site directly. While these keychains do simplify account access to multiple websites, they are limited in that they typically only provide account management on the computing device that the browser is executing in, thus when moving to a new computing device all passwords must again be updated. In addition, such keychains are typically limited to only certain types of account information, such as username and/or password information.

Recently, the use of social-networking websites to communicate has drastically increased. These websites provide a user an ability to create a personalized page and link themselves to a network of people they know. The users can then post information to their entire network, or communicate messages to individual members of their network or other users of the social-networking website. Often, users are provided an ability to share media with other users of a social-networking website. Many Internet users are members of multiple online networking utilities, because each of these communities may be directed to networking for a different purpose. For example, an Internet user may desire to utilize MySpace.com® to connect with personal contacts, Facebook.com® to connect with academic contacts, and LinkedIn.comg to connect with business contacts.

The above mentioned social-networking sites have increasingly provided users an ability to publish greater varieties of content to their personalized postings, including music, videos, photos, and blogs. Typically, in order to publish such content, a user must visit and login to a particular social-networking website, and utilize functionalities internal to the site to locate content to be published and upload that content to the site.

To ease this time-consuming task, some social-networking sites such as Plaxo.com® have provided users an ability to upload photos directly from a photo sharing website such as Flicker.com®. Other solutions have been proposed that allow a user to login to multiple social-networking sites simultaneously. For example, U.S. Pat. Pub. No. 2007/0150613 describes a website that allows a user to login to a plurality of social-networking websites simultaneously. The website may also provide the user with updates regarding messages from these social-networking websites when the user is currently logged in.

Other solutions have been proposed that seek to merge the functionalities of media management applications and social-networking websites. For example, U.S. Pat. Pub. No. 2007/0169165 describes providing to users a standalone widget, or pop-out digital media player that allows users to communicate through a social-networking site while simultaneously playing or displaying media.

While the above-mentioned solutions may improve a social network user's ability to manage a plurality of social-networking accounts and to interface with media, they do not relieve a user of the time-consuming task of updating content internal to the social-networking website itself. Therefore, if a user seeks to maintain posted content consistently across different social-networking sites, a user must personally keep track of and maintain such content at each site.

Many solutions have been proposed for managing the immense amount of available media and other types of information available through the Internet. For example, media management applications have been developed such as discussed in U.S. Pat. Pub. Nos. 2006/0206493 and 2007/0189737. Commercially available media-management applications include Apple's® Itunes®, Real's® RealPlayer®, and Microsoft's® MediaCenter®.

Media applications such as Apple's Itunes are capable of acquiring a limited amount of both pay and free content over the Internet, and are further adapted to manage and facilitate playback of certain supported media formats and types. These media applications are further adapted to operate other applications, such as media playback or viewing applications that support certain types of media formats.

Some media management applications, such as Apple's Itunes, are catered towards allowing a user access to media stored on a user's local computing device. For example, Itunes is adapted allow a user to select particular media content from the users local computing device. Itunes will then create references to that media and present those references to the user in a browser. Itunes is capable of reading tags on media files to determine information for categorizing such files, for example the artist, album, or genre of a song. Itunes also provides users with an ability to modify these tags such that media files are presented according to the user's categorization preferences.

Media management applications such as Itunes are further constructed to present distinct and separate pages within its media player for different types of media. For example, Itunes presents one user-selectable page for music and a corresponding navigator for managing music. Itunes also presents another user-selectable page for movies. If a user seeks to locate a particular movie, the user must select the movie tab within the Itunes navigator, and then search within the movie page for the local content sought.

Itunes is further adapted to allow users access to a limited amount of free and pay content over the Internet. On a page separate from the pages of the Itunes browser previously discussed, Apple provides the IStore®. The IStore allows a user to search for content provided by Apple through the IStore. If the user seeks to download free content, then the user merely initiates a download of that free content. On the other hand, if the user seeks to download pay content, then the user may provide credit card or other payment information. Once payment has been confirmed, the user may download the content. When content is acquired, it is stored in the user's local memory and is made available according to the Itunes navigator previously discussed.

Other means of acquiring Internet-based media allow a user to visit a website and, upon payment of a subscription, allow users access to media stored on the website provider's server. For example, Rhapsody® allows users to, upon payment of a subscription fee, play music streamed over the Internet. Real's® RealPlayer® allows a user to access Rhapsody's streaming music service directly through its' RealPlayer media management application. RealPlayer also allows a user access to a limited amount, upon payment of a subscription, of streaming video content through the SuperPass® service.

RealPlayer provides an improvement over other known media management applications such as Itunes, in that it allows a user to browse less restricted amount of information available over the Internet. To do so, RealPlayer provides the user an option to open a browser that is separate and distinct from the media player. A user may then use this browser to locate media that may then be downloaded and played or viewed in the distinct RealPlayer application window itself. In the browser, different types of content are separated into separate and distinct pages within the browser window, similar to the Itunes interface previously discussed. RealPlayer also allows a user to initiate a search in the separate and distinct browser that will return text-link results for media of a plurality of different media types, such as text-based news feeds, video news feeds, available music, movies, or other types of media.

However, RealPlayer fails to provide a media management application that enables a high level of ease for a user to access and communicate with respect to a wide variety of media and content types. For example, the previously mentioned browser window associated with the RealPlayer media player is substantially the same as the browsers such as Microsoft's Internet Explorer as previously mentioned. Furthermore, RealPlayer fails to provide any functionality related to avenues of communication such as, for example, social-networking or email.

### SUMMARY

In order to address the problems discussed herein, a need exists for a ubiquitous Internet experience management application adapted to provide, through a singular user interface, users with the ability to access and manipulate a heterogeneous variety of both information types and avenues of communication. A further need exists to provide a singular user interface that makes it efficient and easy for users to navigate and manipulate information and avenues of communications. In addition, a need exists to provide such a ubiquitous user interface that is adapted to operate on a variety of computing devices and across a variety of both hardware and software configurations.

Accordingly, systems and methods providing for improved navigation and aggregation of a multiplicity of Internet based media and communication types are disclosed herein. In one such embodiment, a user interface is provided that includes a user interface window presenting a common format across multiple platforms. The user interface includes a player window defined within the user interface window. The player window includes software adapted to present to the user via the player window a multiplicity of different types of digital content. The user interface further includes an icon palette defined within the user interface window. The icon palette includes a multiplicity of graphically manipulable icons and software adapted to display and manipulate the multiplicity of icons. In some embodiments, each icon is associated with a given item of digital content. The user interface may further include a graphic control interface that includes a plurality of graphically manipulable buttons and software adapted to control the manner in which the items of digital content associated with the multiplicity of icons are presented in the player window. In an embodiment, the graphic control interface and the icon palette are adapted to operate together to enable a user to manipulate a selectable plurality of the icons within the user interface window such that the items of digital content associated with each of the plurality of icons are aggregated and managed as a collective in response to the graphic control interface.

In another embodiment, the user interface is adapted to display a queue window defined within the interface window. The queue window is adapted to enable a user to select one or more icons associated with digital content and designate the digital content for aggregation. In another embodiment, the system includes an account manager. The account manager is adapted to receive from a user and store information relating to a plurality of limited-access Internet based accounts. In an embodiment, the account manager is adapted to automatically log a user in to the plurality of Internet based accounts automatically. In another embodiment, the account manager is adapted to simultaneously log a user in to the plurality of Internet based accounts. In yet another embodiment, the account manager is adapted to publish content to a plurality of Internet based accounts. In an embodiment, the account manager is adapted to publish either media content or messages to a plurality of Internet based accounts. In a related embodiment, the accounts are social networking accounts. According to this embodiment, the account manager is operative to log in to at least one social networking account and operate internal functions of the social networking site in order to upload content for publication.

In another embodiment, a method of providing, to a user via a user interface, an improved tool for managing and aggregating multimedia and communication digital content is disclosed herein. In various embodiments, the method includes providing, to a user, a user interface window presenting a common format across multiple platforms. The method further includes providing, via the interface window, a player window defined within the user interface window that includes software adapted to present to the user a multiplicity of different types of digital content. The method also includes providing, via the interface window, an icon palette defined within the user interface window that includes software adapted to allow the user to display and manipulate the multiplicity of graphically manipulable icons. In an embodiment, each icon is associated with a given item of digital content. The method may also include providing, via the interface window, a graphic control interface that includes a plurality of graphically manipulable buttons and software adapted to allow the user to control the manner in which items of digital content associated with the multiplicity of icons are presented in the player window. In an embodiment, providing the graphic control interface and the icon palette includes providing the graphical control interface to be operable together with the icon palette to enable the user to manipulate a selectable plurality of the icons within the user interface window such that the items of digital content associated with each of the plurality of icons are aggregated and managed as a collective in response to the graphic control interface.

In another embodiment, a method of accessing a multitude of different media content and communication types is disclosed herein. According to this embodiment, the method includes operating, at a computing device coupled to a network, a user interface defined by a user interface window. The method may further include receiving, at the computing device, representations of a multitude of media content accessible by the server. In another embodiment, the method includes displaying, via the user interface, representations of the plurality of media content that include a plurality of graphically manipulable icons presented via an icon palette defined within the user interface window. The method may also include receiving, via user manipulation of the plurality of graphically manipulable icons and manipulation of a graphic control interface that includes a plurality of graphically manipulable buttons and software adapted to allow the user to control which items of digital content associated with the multiplicity of icons are presented, an indication of content the user desires to access. In an embodiment, the method includes acquiring, from the server coupled to the network, content associated with the indication of content the user desires to access. In another embodiment, the method includes displaying, via a player window defined within the user interface window, the content associated with the indication of content the user desires to access.

### BRIEF DESCRIPTION OF THE FIGURES

The invention may be more completely understood in consideration of the following detailed description of various embodiments of the invention in connection with the accompanying drawings, in which:

FIG. 1 illustrates generally a block diagram of an embodiment of an Internet experience management (IEM) system according to various aspects of the invention described herein.

FIG. 2 illustrates generally one embodiment of a system in which IEM is adapted to operate in according to various aspects of the invention described herein.

FIG. 3 illustrates generally one embodiment of a user interface of IEM according to various aspects of the invention described herein.

FIG. 4 illustrates generally a flow chart of a method of providing an IEM according to various aspects of the invention described herein.

FIG. 5 illustrates generally one embodiment of combinable icons according to various aspects of the invention described herein.

FIG. 6 illustrates generally one embodiment of an IEM that includes an account manager according to various aspects of the invention described herein.

FIG. 7 illustrates generally one embodiment of IEM adapted to present, via UI, an account manager interface.

FIG. 8 illustrates generally one embodiment of a user interface including a media upload interface according to various aspects of the invention described herein.

FIG. 9 illustrates generally one embodiment of a user interface including a message center according to various aspects of the invention described herein.

FIG. 10 illustrates generally one embodiment of a user interface according to various aspects of the invention described herein.

FIG. 11 illustrates generally one embodiment of a user interface according to various aspects of the invention described herein.

FIG. 12 illustrates generally one embodiment of a user interface deep according to various aspects of the invention described herein.

FIG. 13 illustrates generally one embodiment of a user interface according to various aspects of the invention described herein.

FIG. 14 illustrates generally one embodiment of a user interface depicting search history according to various aspects of the invention described herein.

FIG. 15 illustrates generally one embodiment of a user interface depicting a search history according to various aspects of the invention described herein.

FIG. 16 illustrates generally one embodiment of a user interface depicting a search according to various aspects of the invention described herein.

FIG. 17 illustrates generally one embodiment of a user interface depicting a photo content display according to various aspects of the invention described herein.

FIG. 18 illustrates generally one embodiment of a user interface depicting a blog content display according to various aspects of the invention described herein.

FIG. 19 illustrates generally one embodiment of a user interface depicting a branded channel according to various aspects of the invention described herein.

FIGS. 20 and 21 illustrate generally one embodiment of a user interface providing access to both free and pay content according to various aspects of the invention described herein.

FIG. 22 illustrates generally one embodiment of a user interface that adapted to manage social networking according to various aspects of the invention described herein.

FIG. 23 illustrates generally one embodiment of a user interface that adapted to allow a user to broadcast according to various aspects of the invention described herein.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE PREFERRED EMBODIMENTS

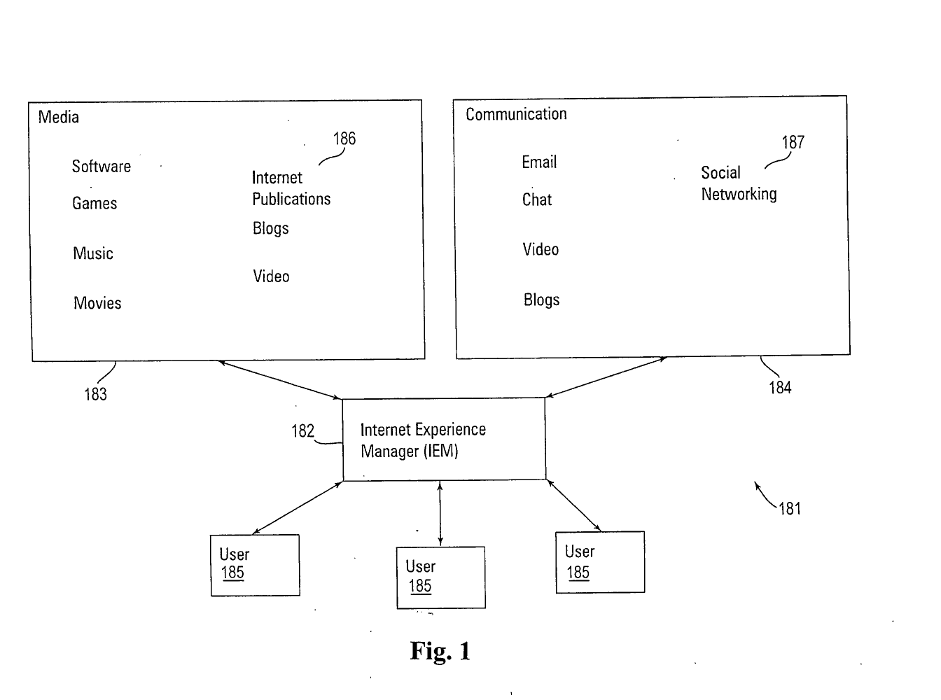

FIG. 1 is a block diagram depicting an embodiment of an Internet experience management system 181 according to various aspects of the invention described herein. System 181 includes Internet Experience Manager (IEM) 182. IEM 182 provides and manages access and aggregation of digital multimedia and communication content by a user over the Internet. In an embodiment, IEM 182 is adapted to communicate with a multitude of media sources 183 in order to provide users 185 with access to digital content 186. IEM may also be adapted to enable users 185 to play or view media content, such as by managing different programs and versions of needed to view or access different media or media file types. Examples of media types IEM 182 may be adapted to manage include video, music, movies, television shows, programs, games, Internet publications, and blogs. Digital media 183 managed by IEM 182 may be located on content-provider servers, media devices 183, or any other devices otherwise available to system 181.

As also shown in FIG. 1, IEM 182 may be adapted to manage a plurality of types of Internet-based avenues of communication in order to better connect users 185. Examples of communication types IEM 182 may be adapted to manage include email, chat, Voice Over IP (VOIP), and social networking. In various embodiments, IEM 182 may be adapted to operate a plurality of communication types 184 or implementations (e.g. a particular chat website or email account) simultaneously. In another embodiment, IEM 182 may be adapted to manage user 185 access and manipulation of one or more communication types 184 and one or more types of media content 183 simultaneously.

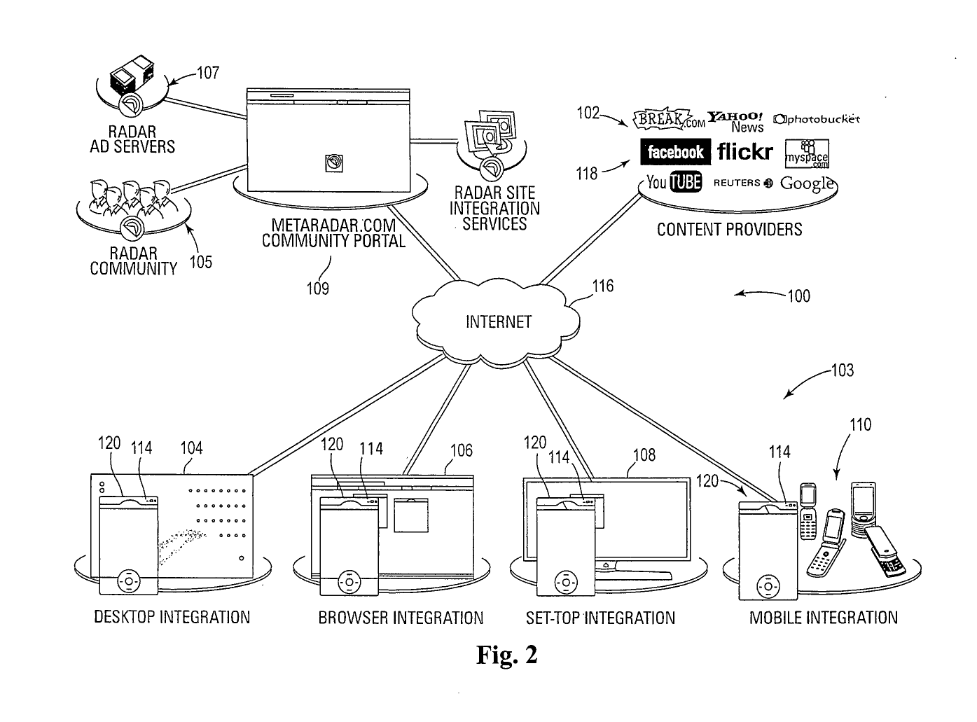

FIG. 2 illustrates generally one embodiment of a system 100 in which IEM 182 is adapted to operate in. System 100 includes examples of content providers IEM 182 may be adapted to communicate with. System 100 also includes media devices 103. Media devices 103 and content providers 118 are coupled to a network such as the Internet 116. IEM 182 may be adapted to operate on a plurality of different types of media devices 183 and in a plurality of different implementations. In one embodiment, IEM 182 is adapted to operate, at least in part, through an application running on a computing device such as personal computer 104. In another embodiment, IEM 182 is adapted to operate via an internet browser 106. In still another embodiment, IEM 182 is adapted to operate through a set-top box 108 or other computing device coupled directly to a display. In another embodiment, IEM 182 is adapted to operate on mobile device 110.

In some cases, media devices 103 may also be directly connected to each other through a local area network (LAN). System 100 may also include a community of users 105 and ad servers 107 connecting to Internet 116 through community portal 109.

Media devices 103 are intended to represent a wide variety of platforms and devices capable of storing, displaying, or otherwise making digital media content 118 available to a user. Computers 104 may be any number of known desktop and laptop computers utilizing Linux®, Microsoft® Windows®, Apple OS X, or other known operating systems. Wireless communication devices 110 may be smartphones such as a Blackberry®, Apple's iPhone®, or other such devices. Other examples of media devices 103 include portable media players (PMPs), DVD players, gaming systems, and other “smart” devices.

In system 100 depicted in FIG. 2, each media device 103 allows users 185 to communicate with IEM 182. In an embodiment, IEM 182 takes the form of a series of instructions implemented by each media device to provide a user interface (UI) to users 185. IEM 182 may take the form of instructions executable on media device 103, one or more servers, or any combination of media devices 103 and servers. In various embodiments, a UI provided by IEM 182 is a ubiquitous user interface common to all devices implementing IEM 182.

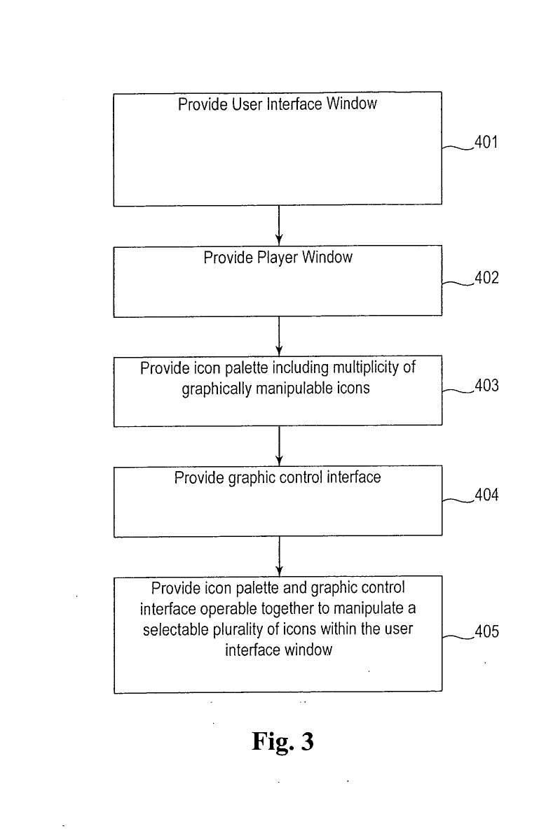

IEM 182 and its user interface are discussed further below, and with reference to FIGS. 3-24. Additional details of the invention, including IEM 182, are included in the file and programs contained in the attached compact disc, which comprise the contents of this application and are hereby incorporated by reference.

FIG. 3 illustrates generally one embodiment of a user interface 301 of IEM 182 according to various aspects of the invention described herein. User interface 301 includes a user interface window 305. In various embodiments, user interface 301 is constructed to present a common format across various different media devices 203 and platforms. User interface 301 also includes player window 304. In an embodiment, player window 304 includes software of program instructions adapted to present to a user, via the player window, a multiplicity of different types of content 103. For example, player window 304 may be adapted to present to a user a playable movie or video clip, a photograph, textual information or any other type of content. In various embodiments, player window 304 includes software of program instructions adapted to cause IEM 182 to convert, encode, or otherwise manipulate media content. In one such embodiment, content is displayed in a common format across multiple media content types and formats.

User interface 301 may further include icon palette 302. Icon palette 302 may include a multiplicity of graphically manipulable icons 306. Icon palette 302 may further include software adapted to display and manipulate a multiplicity of icons 306. In an embodiment, each icon 306 of the multiplicity of icons 306 is associated with at least one given item of digital content 103. In another embodiment, each icon of the multiplicity of icons 306 is associated with a single given item of digital content.

In various embodiments, graphically manipulable icons 306 are associated with various operations of IEM 182. User 185 selection of one or more icons 306 may initiate one or more of these operations. Selection of icons 306 may cause IEM 182 to initiate display or playback of one or more associated items of digital content 183 in player window 304.

In the alternative, selection of icons 306 may cause IEM 182 to initiate display of other icons 306. For example, selection of particular icons 306 may cause IEM 182 to display icons 306 that represent similar media to media currently displayed in player window 305, particular content a user has designated as a favorite, or a type or category of content 183.

Selection of icons 306 may initiate content aggregating operations of IEM 182. For example, selection of icons 306 may cause IEM 182 to initiate a search for particular digital content 183. In another embodiment, selection of icons 306 may cause IEM 182 to allow a user 185 access to one or more types of communication 184.

User interface 301 may also include graphic control interface 303. Graphic control interface 303 may include a plurality of graphically manipulable buttons 307 and software adapted to control the manner in which items of digital content 183 associated with the multiplicity of icons 306 are presented in player window 304. In an embodiment, graphic control interface 303 is defined within user interface window 305.

In an embodiment, graphical control interface 303 includes playback manager 308. In one embodiment, playback manager 308 is adapted to provide a user with control over content displayed in player window 304, such as allowing a user to stop or advance video playback, or to allow a user to scroll through a photo album. In another embodiment, playback manager 308 is adapted to allow a user to control icons 306 displayed in icon palette 302. In one such embodiment, a user may be provided an ability to scroll through various collections of icons 306 by operating playback manager 308.

In some embodiments, graphical control interface 303 includes graphically manipulable buttons 307. Buttons 307 provide a user with controls to manipulate operation of IEM 182. In the embodiment of FIG. 3, graphical control interface 303 includes buttons that direct IEM 182 to search for content, share content with others, designate content as “favorite”, or to queue a file for downloading. Other buttons 307 illustrated may allow a user to access system functions and manage data.

Icon palette 302 and graphical control interface 303 may operate to collectively manipulate icons 306. In an embodiment, icon palette 302 is adapted to operate with graphic control interface 303 to enable a user 185 to manipulate icons 306 such that content 183 associated with icons 306 are aggregated and managed as a collective. Selection of one or more buttons 307 may modify content and/or IEM operations associated with icons 306, or icons 306 themselves. For example, selection of buttons 307 may modify content displayed in player window 304, determine which icons 306 are displayed in icon palette 302, or cause icon palette 302 to communicate to a user information relating to content (e.g., whether content is currently available for viewing, downloading, or available for download, accessible formats for content, . . . etc.). As another example, selection of buttons 307 may cause IEM 182 to aggregate content 183.

In an alternative embodiment, selection of one or one or more icons 306 may modify which buttons 307 or other controls, such as playback manager 308, are made available to a user via graphical control interface 303. User selection of one or more icons 306 may also modify actions associated with particular buttons 307 and/or other controls.

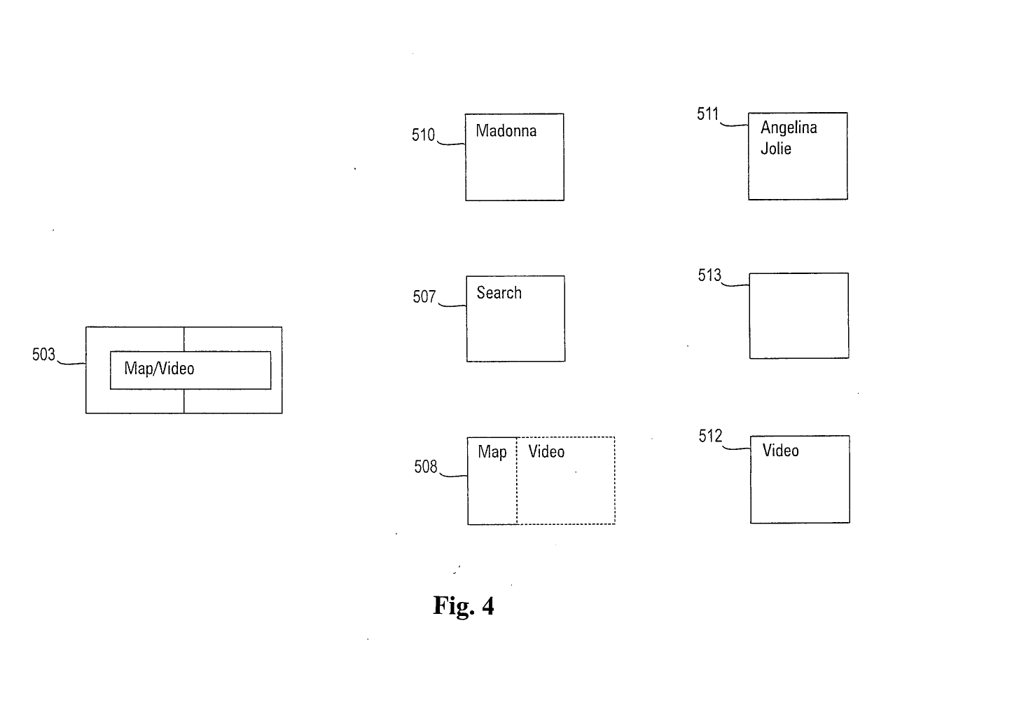

FIG. 4 illustrates generally a method of providing an IEM 182 according to various aspects of the invention described herein. At 401, a user is provided user interface window 305. In various embodiments, user interface window 305 presents a common format across multiple platforms. At 402, player window 304 is provided. In an embodiment, player window 304 is defined within user interface window 305. In an embodiment, player window 304 includes software adapted to present to a user a multiplicity of different types of digital content.

At 403, icon palette 302 is provided. Icon palette 302 may be defined within user interface window 305. In various embodiments, icon palette 302 includes software adapted to allow a user to display and manipulate a multiplicity of graphically manipulable icons 306. In various embodiments, each of the multiplicity of graphically manipulable icons 306 are associated with a given item of digital content.

At 404, a graphic control interface 303 is provided. In an embodiment, graphic control interface 303 is defined in interface window 305. In various embodiments, graphic control interface 303 includes a plurality of graphically manipulable buttons and software adapted to allow a user to control the manner in which items of digital content associated with the multiplicity of icons are presented in player window 304. At 405, providing graphic control interface 303 and icon palette 302 includes enabling graphic control interface 303 and icon palette 302 to be operable together to enable a user to manipulate a selectable plurality of icons 306 within the user interface window such that items of digital content associated with each of the plurality of icons 306 are aggregated and managed as a collective in response to graphic control interface 303.

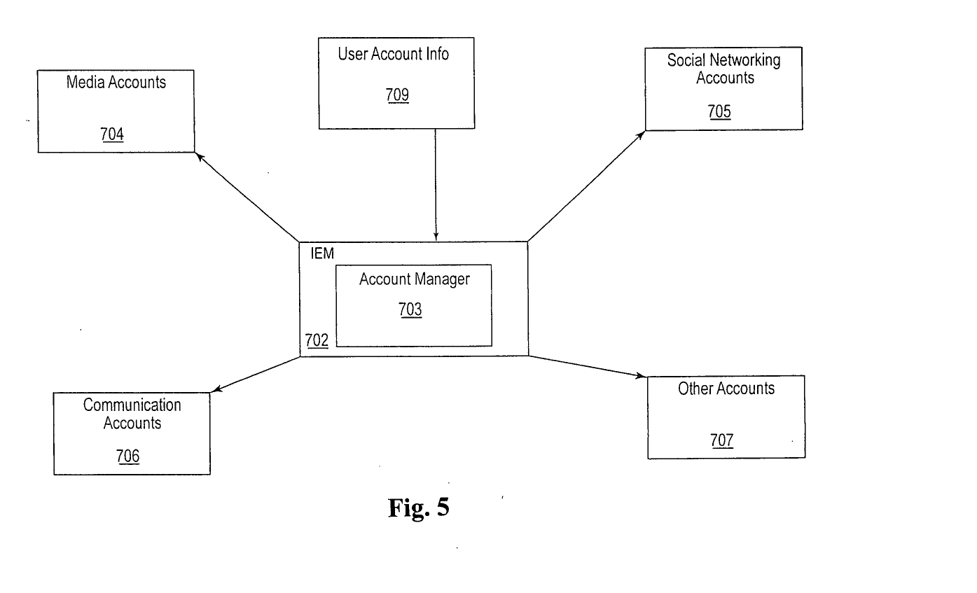

FIG. 5 illustrates generally one embodiment of combinable icons 506 according to various aspects of the invention described herein. As illustrated in FIG. 5, a user may be provided the ability to graphically combine two or more icons 506. In various embodiments, a user may graphically combine two or more icons 506 by manipulating at least one icon 506 into graphical proximity with at least one other icon 506. In an embodiment, a user combining two or more icons 506 initiates one or more operations of IEM 182.

For example, IEM 182 may present, via UI 301, one or more combinable icons 506 that represent particular artists, such as the Madonna icon 510 and Angelina Jolie icon 511 in FIG. 5. IEM 182 may further present search icon 507, map icon 508, and video icon 512. In this example, a user may combine Madonna icon 510 with map icon 508, and thus cause IEM 182 to display in player window 302 a map including an indication of Madonna's current location. In another example, a user may combine Angelina Jolie icon 511, Madonna icon 510, and search icon 507 to initiate a search of content featuring Angelina, Madonna, or both artists. Should a user further combine video icon 512 with these icons, a search may return only videos featuring the artists.

In a related embodiment, a user combination of two or more icons 506 may cause IEM 182 to provide to the user a new icon that represents a combination of information represented by the icons. For example, a user combination of map icon 508 and video icon 512 may result in IEM 182 providing map/video icon 503. Map/video icon 503 may represent a selectable map of the globe that provides users with an ability to select particular geographical regions and acquire video media depicting video recorded in that region.

In some embodiments, IEM 182 is adapted to automatically provide combinable icons 506 for selection by a user. For example, IEM 182 may be adapted to, depending on one or more contexts of a user search, provide combinable icons 506 that a user will likely find helpful in the context of the user's search. In another embodiment, users 185 are provided an ability to create customized combinable icons 506 for particular purposes.

As previously mentioned, IEM 182 may be implemented in a plurality of different media devices 103 which provide users with various means of operating the device. Some media devices allow a user to control a user interface through a mouse and keyboard, while others provide touch screen control. For mouse and keyboard media devices, combinable icons 506 may be combined by user selection of a first icon and user movement of first icon in proximity to a second icon. For touch screen control devices, combinable icons may be combined by user selection of multiple icons simultaneously and simultaneous movement of the multiple icons in proximity to each other. In the alternative, a user may select an individual icon and move it in proximity to a stationary icon.

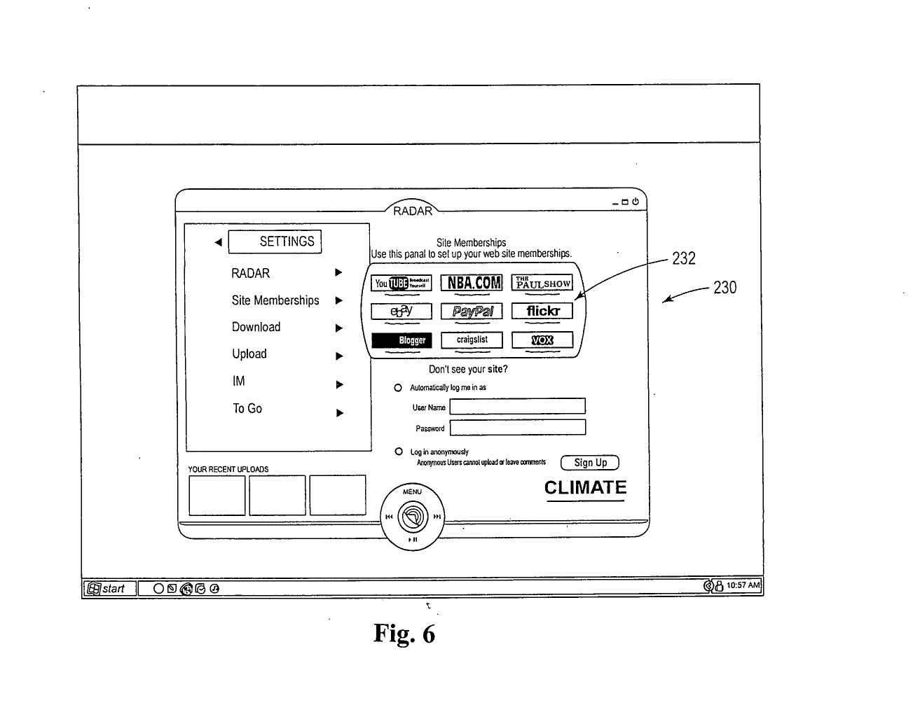

FIG. 6 illustrates generally one embodiment of an IEM 182 that includes account manager 702. In various embodiments, account manager 702 is adapted to manage account information 709 such as usernames, passwords, credit card information, or any other information relevant to a plurality of content and communication types managed by IEM 182. Account manager 702 may be adapted to receive and store account information 709 provided by a user. In an embodiment, account manager 702 is adapted to utilized received and stored account information 709 in order to automatically login to a plurality of user accounts. In various embodiments, account manager 702 is adapted to manage account information and provide access to sites such as content acquisition sites 704, communication sites 706, social networking sites 705, and other sites 707, for example, personal banking sites.

According to a related embodiment, account manager 702 is adapted to access one or more Internet web sites to access information requested by, or likely desired by, a user. For example, account manager 702 may be adapted to access any one of email, chat, social networking, or other communication sources to obtain messages.

In another embodiment, account manager 702 may be adapted to automatically access sites to acquire updates of published content. In an embodiment, a user is provided an ability to designate sites for which the user desires updates of published content. In related embodiments, account manager 702 is adapted to access pay or limited-access sites by utilizing account information 709. In some embodiments, account manager 702 is adapted to automatically and periodically visit designated sites for messages or updates.

In another related embodiment, account manager 702 may be adapted to access one or more sites to update information at those sites. For example, if a user maintains an account with a plurality of different blogging sites and the user desires to publish a blog entry to a plurality of the sites, account manager 702 will accept from a user a single representation of blog content, and publish a copy of that content to the plurality of blogging sites.

In various embodiments, a user may be provided an ability to automatically update or collect information related to sites adapted to publish content such as social networking sites 707 or personal web pages. In one such embodiment, IEM 182 is adapted to provide a central content repository 705 for a user's personal information. In an embodiment, account manager 702 may be adapted to provide to a user a plurality of data fields 703 that are typically common to such content publication sites. Account manager may provide a user data fields 703 including: name, username, contact information, personal descriptions, or any other personal information. Account manager 702 may also provide a content designator a user to designate certain content for publishing. For example, the content designator may provide a user with an ability to designate certain photographs, photo albums, or videos that the user wishes to publish.

In an embodiment, IEM 182 is adapted to automatically access one or more publication sites designated by the user for publication. According to this embodiment, IEM 182 is further adapted to update information posted on these sites. In one related embodiment, IEM 182 is also adapted to automatically operate internal features of these sites in order to update posted information. For example, IEM 182 may be adapted to automatically locate and operate file location and uploading functions internal to sites in order to upload and publish information managed by IEM 182.

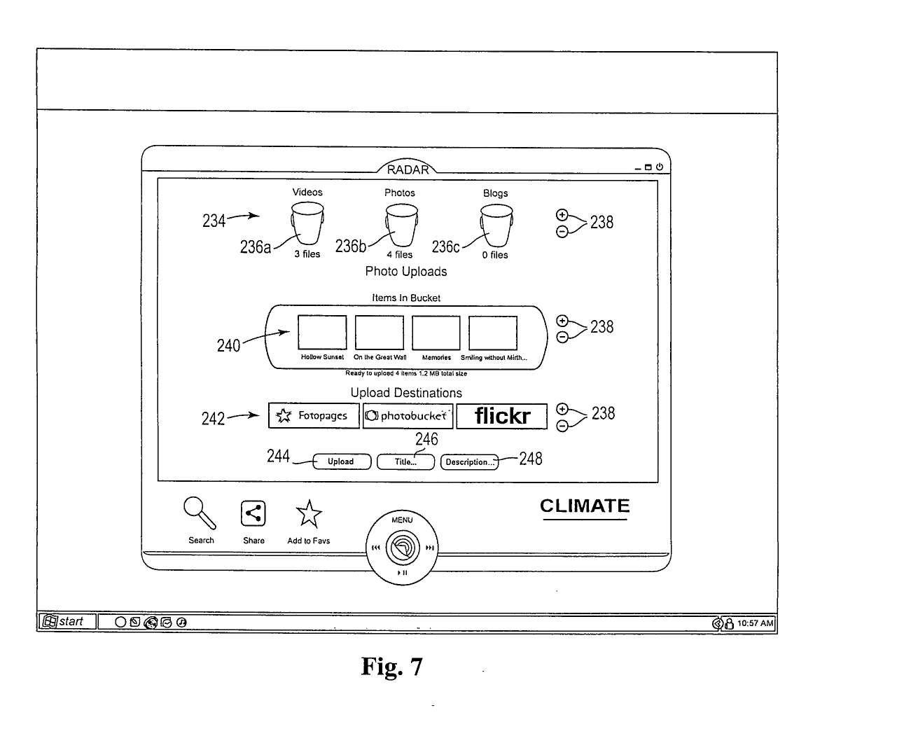

FIG. 7 illustrates IEM 182 adapted to present, via UI 301, an account manager 702 interface 230. Account manager 702 is adapted to facilitate convenient and efficient workflow by providing a user with a single place to manage a multitude of accounts. According to the illustrated embodiment, UI 301 presents an accounts window 232. Accounts window 232 includes a plurality of icons that represent accounts of a user. A user may be provided with an ability to add, remove, or edit accounts across various sites. The illustrated embodiment shows various account manager 702 settings that may be made available to a user such as offering membership information, downloading, uploading, instant messaging, and other functions. Further, IEM 182 may be adapted to provide users with an ability to initiate a new account at a site directly from UI 301.

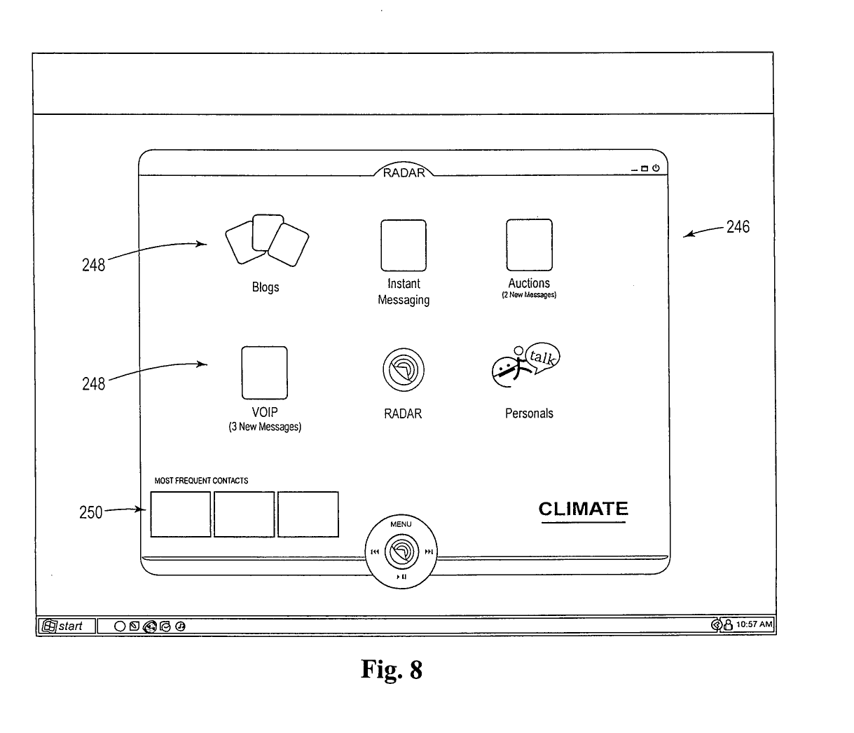

FIG. 8 illustrates account manager 702 of IEM 182 adapted to perform upload of content to multiple sites. In the embodiment depicted, UI 301 includes a plurality of media content bucket icons 236 that are each adapted to represent a type of media content. UI 301 further includes site designator icons 242, selection of which allows a user to define sites to receive uploaded content. In this example embodiment, bucket 236a represents videos, 236b represents photos, and 236c represents blogs. Although the term “bucket” is used to describe a file container, other graphical icons, such as bags, boxes, or even a standard UI control like a list, could be interchanged for the term “bucket.” Scroll buttons 238 allow a user to view and select individual media content buckets 236. In a central portion of UI 301, individual items 240 of a selected media type contained in a bucket 236 are displayed. In this example, four photos of photo bucket 236b are displayed and available for uploading.

This multiple uploading functionality of IEM 114 enables users to upload content to multiple sites. A user may drop files into buckets 236 which defines which files may be uploaded. Further, a user is provided an ability to label content with tags. These tags can be predefined per bucket or set by a user during upload. In various embodiments, IEM 182 is adapted to automatically log a user in to each site designated for uploading and uploads the files. In an embodiment, IEM 182 uses software or other mechanisms internal to sites in order to upload content. A user may continue to browse content using IEM 182 while uploading occurs.

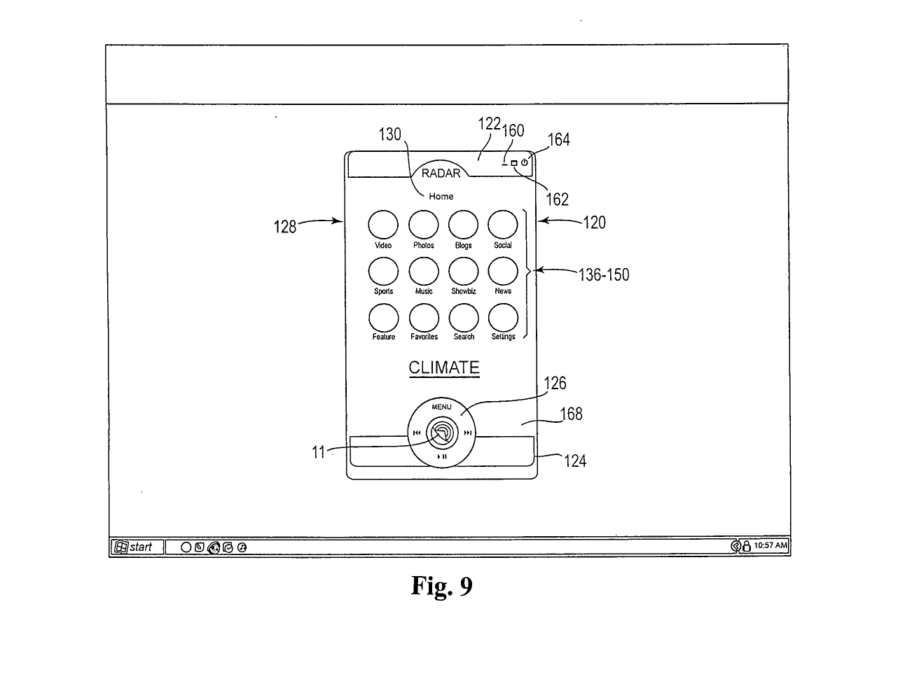

FIG. 9 illustrates generally one embodiment of IEM 182 adapted to provide a message center. IEM 182 may be adapted to integrate with multiple different communication types and sources for those types. Messages from all sites may be represented in a single inbox so that a user does not have to go to each communication source in order to view all of the messages the user may have received.

IEM 182 may further allow a user to write a single message and send it via a plurality of communication types and sources. In an embodiment, IEM 182 is adapted recognize what account a message came from and automatically use that account when sending the reply.

In one embodiment as depicted in FIG. 9, message center 246 or UI 301 displays a number of messaging icons 248, for example, blogs, instant messaging, auctions, VOIP, RADAR and personals. Also displayed are icons 250 representing most-used contacts, which can be used to quickly pull up information and contact persons a user frequently communicates with. IEM 182 provides an integrated outbound and inbound messaging system that encompasses a full range of web communications.

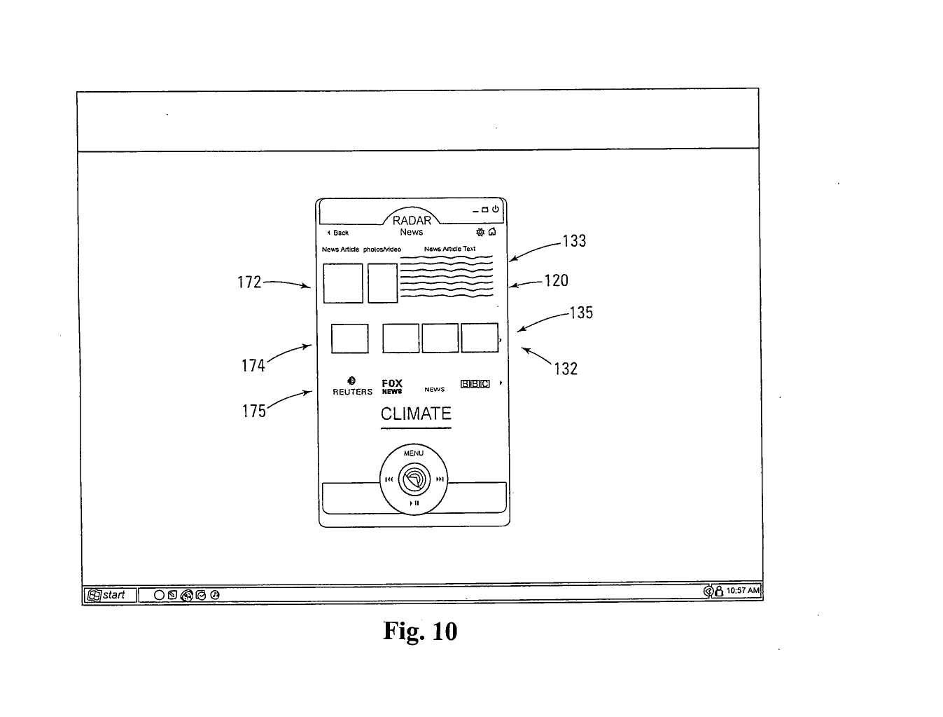

FIG. 10 illustrates one embodiment of an alternative representation of UI 301. According to this embodiment, UI 301 is presented in a handheld player window 128. In the embodiment depicted, UI 301 includes a graphical top-frame bar 122, bottom-frame bar 124, title region 128, ad region 134, and title 130. UI 301 also includes icon palette 301. Icon palette 301 includes a plurality of icons 136-150. UI 301 further includes graphical control interface 124. Graphic control interface 124 includes playback manager 126. UI 301 may also include playback window 304, although the embodiment depicted in FIG. 10 does not include playback window 304.

In one embodiment, media content icons 136-150 include subject categories such as videos, photos, blogs, social, sports, music, showbiz, and news, respectively. Depicted media content icons 136-150 are the default icons of one embodiment of UI 301 of IEM 182. A user may change the default content icons. Icons 136-150 may be adapted to represent categories of content as depicted in FIG. 10. These icons 136-150 may be user selectable to cause IEM 182 to display other icons that represent particular content or other categories of content. As depicted, multiple types of content may be managed by IEM 182.

UI 301 may include a number of functional icons, including minimize icon 160, maximize icon 162, and exit icon 164. In other embodiments, additional functional icons may be located on top-frame bar 122. Other icons displayed may include tools icon 166, and volume control icon 168. In some embodiments, title region 128 includes not only a title 130, but may also include a “home” icon, and/or forward/back navigation arrows.

In one embodiment, playback manager 126 includes a set of textual and/or graphical indicators that are user selectable to cause IEM 182 to play, stop/pause, advance or reverse playback, or display one or more menus. Playback manager 126 also may also include control button 170.

Handheld player window 128 may be of a relatively small size to fit a small screen such as that of mobile device 210, or may consume a relatively small portion of a larger monitor, simulating a mobile device 210.

Widescreen player window 305 of UI 301 as depicted in FIG. 3 above is adapted to present a larger size adapted to be displayed on a larger, traditional monitor, such as a computer or television monitor. In some embodiments, control button 166 is adapted to be user selectable to toggle UI 301 between handheld and widescreen player window 305 modes. As described below, in widescreen mode, a larger number of icons and media content may be presented by IEM 182.

Minimize and maximize icons 160 and 162 may be provided via player window 305 or 128. Minimize and maximize icons 160 and 162 may be user selectable to cause IEM 182 to size UI 301 to fill all or only a portion of a device or monitor screen. Player window 305 128 may further include exit icon 164 that is user selectable to cause IEM 182 to close or exit.

Title region 128 may display a title 130 associated with UI 301 display content, including menu content and icons 306. Ad region 134 may display advertisements, which may or may not change from screen to screen in terms of content and location.

Tools icon 166 is adapted to be user selectable to cause IEM 182 to display tools available via IEM 182, such as search, share, and so on, available to a user.

In some embodiments, IEM 182 is adapted to present to a user icons 306 adapted to cause IEM 182 to display or locate content 183 of one or more types. For example, a user may browse or navigate content based on a content type simply by selecting a particular icon 306 on the home menu as displayed on UI 301. Playback manager 126 may be adapted to be user selectable to allow a user to move forward and back through menus, icons, and content displayed on UI 301.

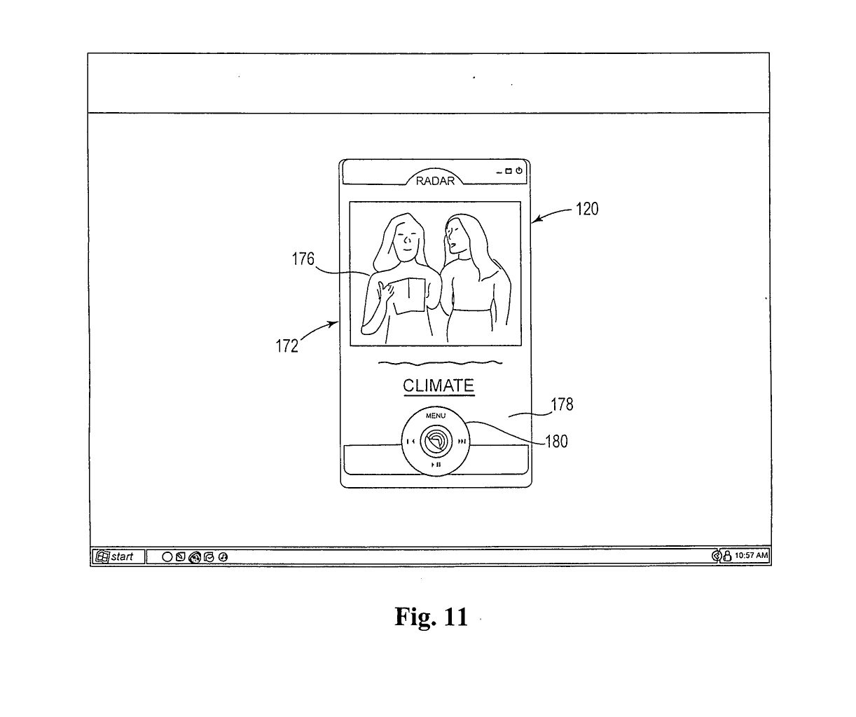

FIG. 11 depicts a UI 301 displaying news content following the selection of news icon 150. In this embodiment, a player window 133 is adapted to provide a user with both textual and visual representations of a news story. In one embodiment, player window 133 may be adapted to periodically update player window with news content. In an embodiment, IEM 182 further provides, via player window 133, a user selectable link to display a full article. UI 301 of FIG. 4 also includes icon palette 132. Icon palette 132 includes a plurality of icons 174 175. Icons 306 may be presented to represent any type of supported media, including, for example, photos, videos, or blogs. For examples, users can select what source they wish to receive news from by selecting one of several news source icons 175. In an embodiment, IEM 182 is adapted to support RSS, ATOM, and HTML.

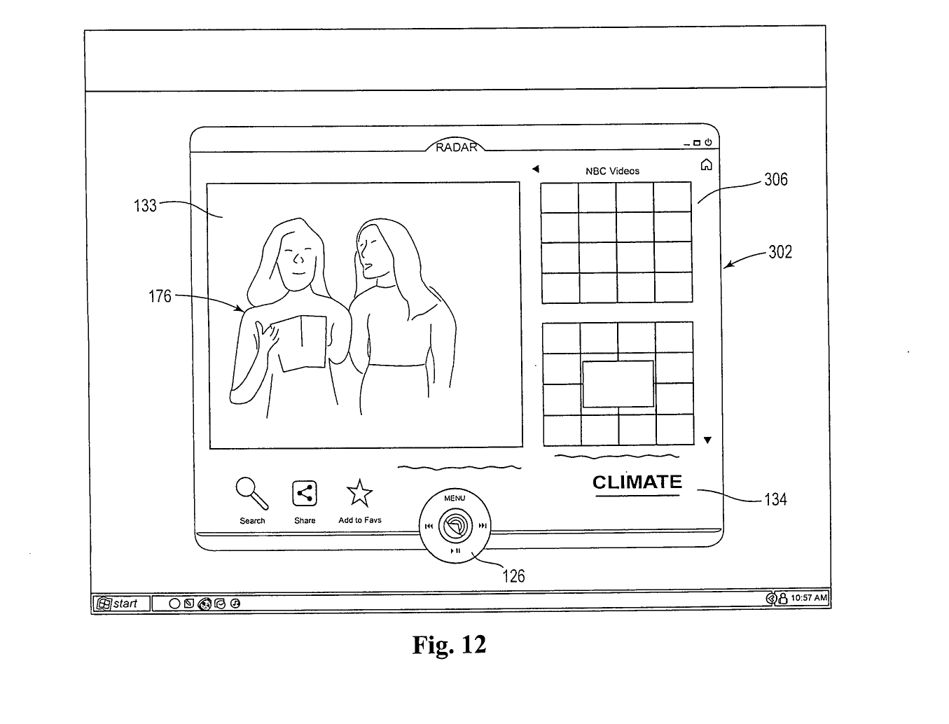

FIG. 12 illustrates UI 301 displaying video-based content in the handheld player window 132. In this embodiment, a video 176 plays in playback window 132. As video 176 progresses, an indicator block 178 appears to traverse semi-circular video progress bar 180, indicating generally how much viewing time remains of video 176.

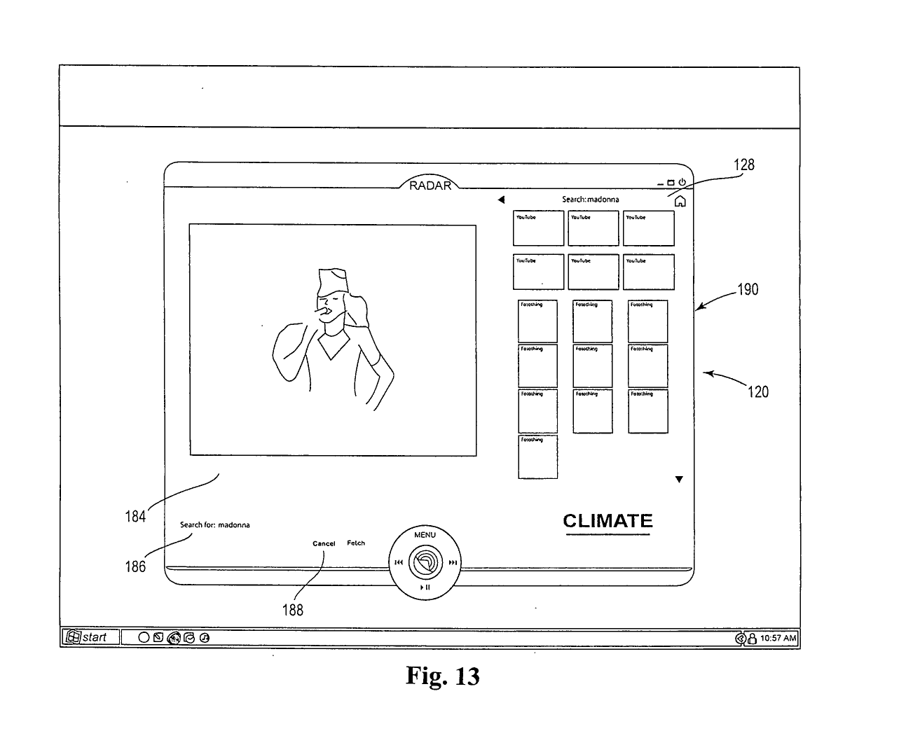

FIG. 13 also illustrates UI 301 displaying the same video 176, only in player window 133. In this embodiment, video 176 plays in playback window 132, but both playback window 132 and video 176 display area are significantly larger than as illustrated in FIG. 5. Further, icon palette 302 is adapted to display icons 306 that represent additional videos for user selection. User selection of one more icons 306 may cause IEM 182 to present content in playback window 132.

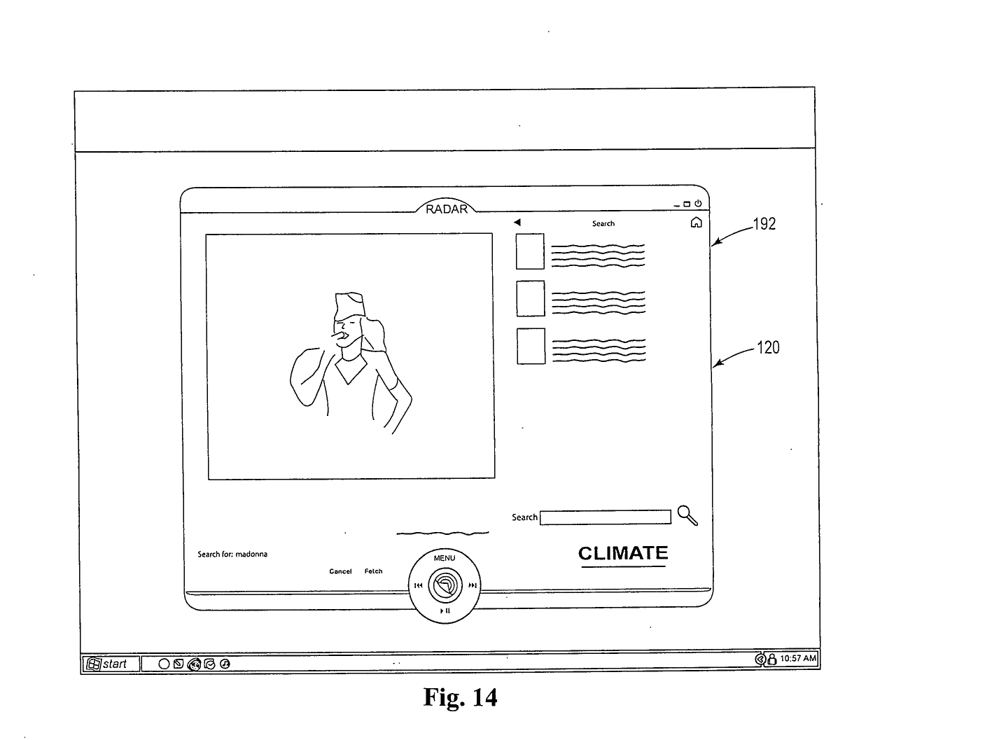

FIG. 14 illustrates one embodiment of a UI 301 that includes an ad region 134 displaying an advertisement. In one embodiment, IEM 182 may be adapted to modify a displayed advertisement that changes as a user navigates UI 301.

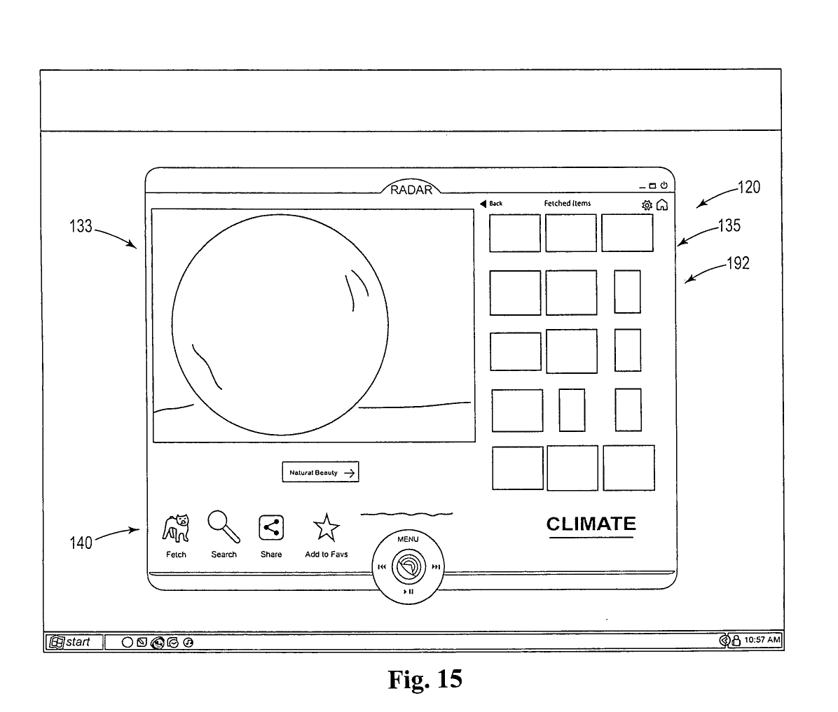

FIG. 15 illustrates UI 301 displaying results of a user-initiated search. In various embodiments, IEM 182 is adapted to accept from a user an indication to perform a cross-media search. According to the embodiment illustrated in FIG. 15, a user has indicated, through entry of text in a search field, that the user seeks content related to the artist Madonna. In an alternative, a user may initiate such a search by combining combinable icons 506 as discussed above. In the embodiment depicted, UI 301 also provides a user with selectable search commands such as “cancel” and “fetch”.

According to the embodiment depicted, UI 301 displays search results 190 which appear directly within icon palette 182. UI 301 may be adapted to display a multitude of content presented in a single view without full page refreshing. In the depicted embodiment, search results 190 include various types of content—blogs, videos, photos, etc.—that are searched and presented together. In the embodiment depicted in FIG. 15, search results are presented as a plurality of icons 306 that depict content and also show a source, such as a hosting site, of the particular item or result.

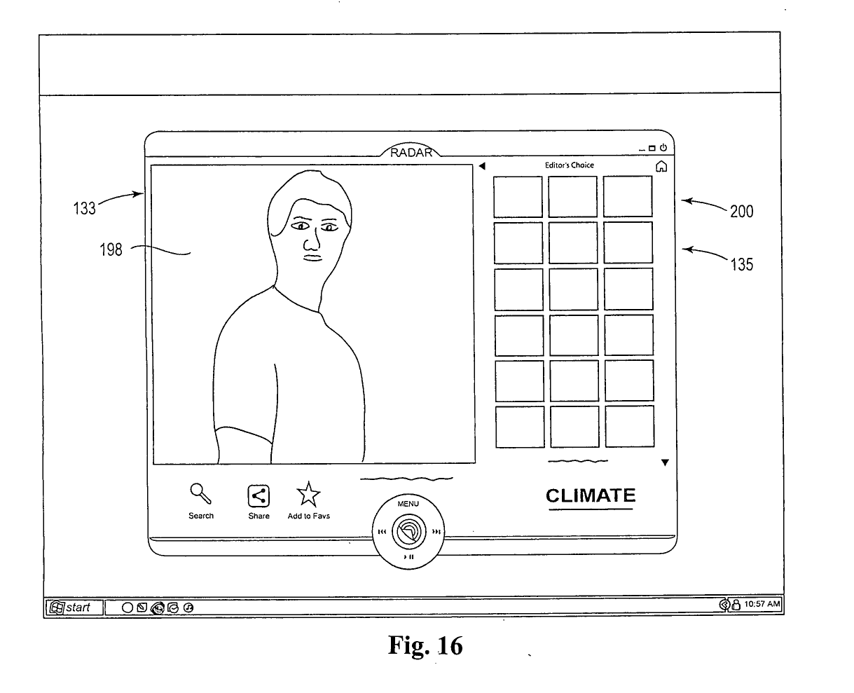

FIG. 16 illustrates further search features and functions. For example, a search result in the form of a video may play in playback window 304 while a menu displaying search history 192 appears in icon palette 302 (Change FIG.). Search history 192 may include all or a portion of a user's previous searches, making them easily available for selection and viewing. Further, the search history may include actual search results that are stored along with the search criteria so that an although an item may no longer be found using the prior search string due to changing a tag modification or other reason, it will still be shown in the results within search history 192. In some embodiments, IEM 182 is adapted to periodically and/or automatically update search history 192 and/or inform a user of any new search results 190.

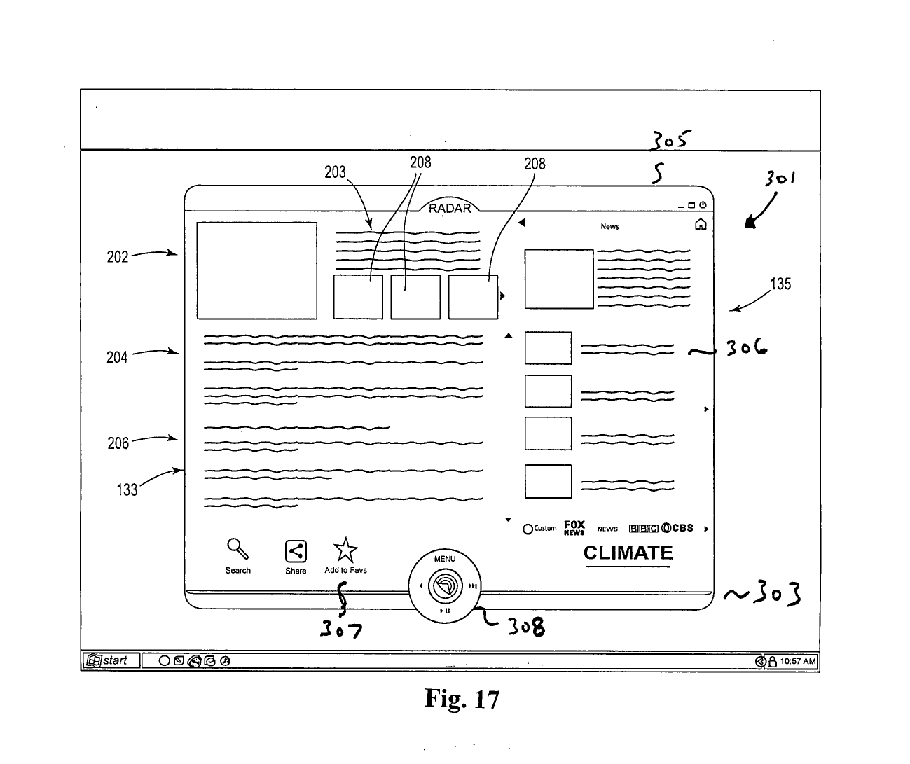

FIG. 16 depicts yet another search function provided by IEM 182. A fetch feature of IEM 182 allows a user to “fetch” media content similar to particular content, such as content currently displayed in playback window 133. According to the embodiment of FIG. 17, a sphere is depicted in playback window 133. Upon user selection of fetch icon 194, IEM 182 is adapted to populate icon palette 135 with icons that present text or graphical previews of related content of all types, including blogs, videos, photos, and more.

In one embodiment, IEM 182 is adapted to periodically and/or automatically search and/or fetch results. In a related embodiment, IEM 182 is adapted to notify a user when a search result changes.

Such searching and fetching functionality facilitates the retrieval, monitoring and identification of dynamic subjective content unlike other currently known browsers and content aggregators.

FIG. 17 illustrates one embodiment of IEM 182 adapted to present, via UI 301, a photo management user interface. According to this embodiment, photo 198 is displayed in playback window 133. At the same time, a plurality of icons adapted to represent photo content are displayed in icon palette 135. In the depicted embodiment, photos represented by the plurality of icons may be default, or “editor's choice” photos, and in other embodiments, may represent searched, fetched or otherwise related or sought-after photo content.

Although icon palette 135 as depicted displays a variety of menu choices, at any time, a user may close the menu by pressing the “menu” button on playback manager 308. Selecting the menu button may cause IEM 182 to modify display of media content being displayed or viewed in playback window 133 to expand into icon palette 135, thereby taking up all available display space of UI 301. This functionality is not limited to the photo content, but extends to all types of content or communication managed by IEM 182.

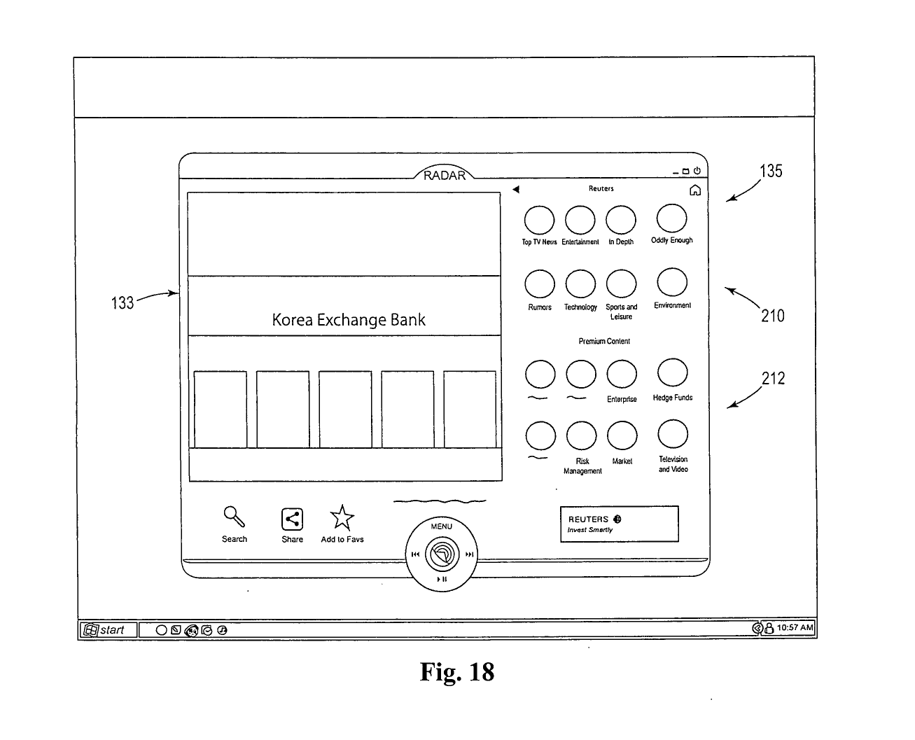

As depicted in FIG. 18, IEM 182 is adapted to display blog content. In the embodiment depicted, UI 301 displays a blog viewer in playback window 133, icons adapted to represent blog content and blog sources in icon palette 135. In some embodiments, IEM 182 may allow users to configure the blog viewer to suit their own choice of font, colors, layout, etc. In this example, blog 202 includes a blog title 203, blog media thumbnails 204, and blog text 206.

Media found within blog 202 is displayed as blog icons. User selection of individual blog icons may cause IEM 182 to display a full blog article or to display other types of content associated with blog 202 such as photos or video.

IEM 182 may further be adapted to perform one or more automatic searches based on the content of blog 202 in order to determine related content. For example, if a user has indicated selection of a blog about Barry Bonds, IEM 182 may perform a search for photos or video of Barry Bonds or his team.

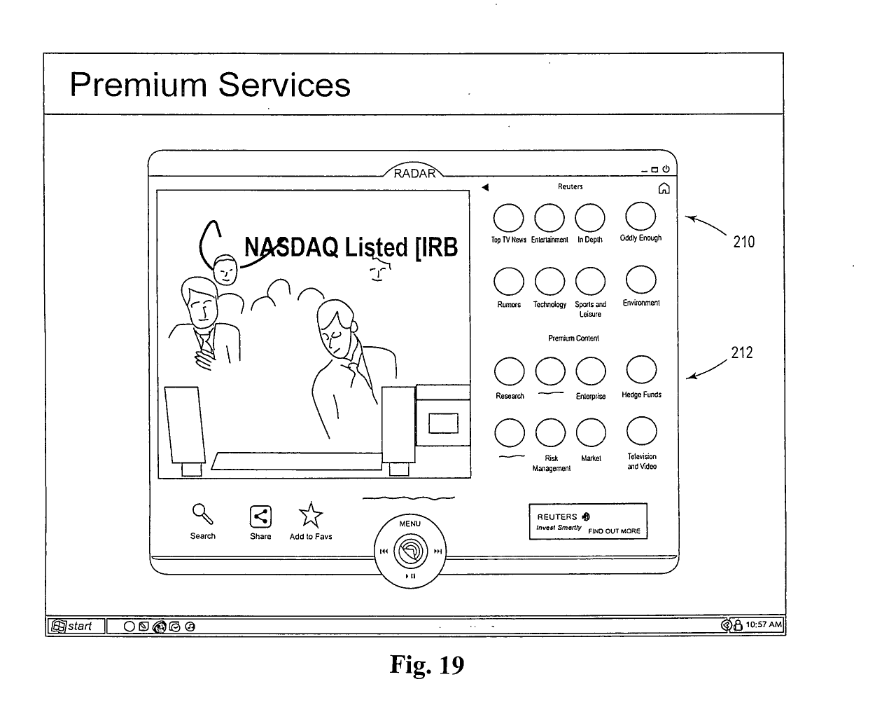

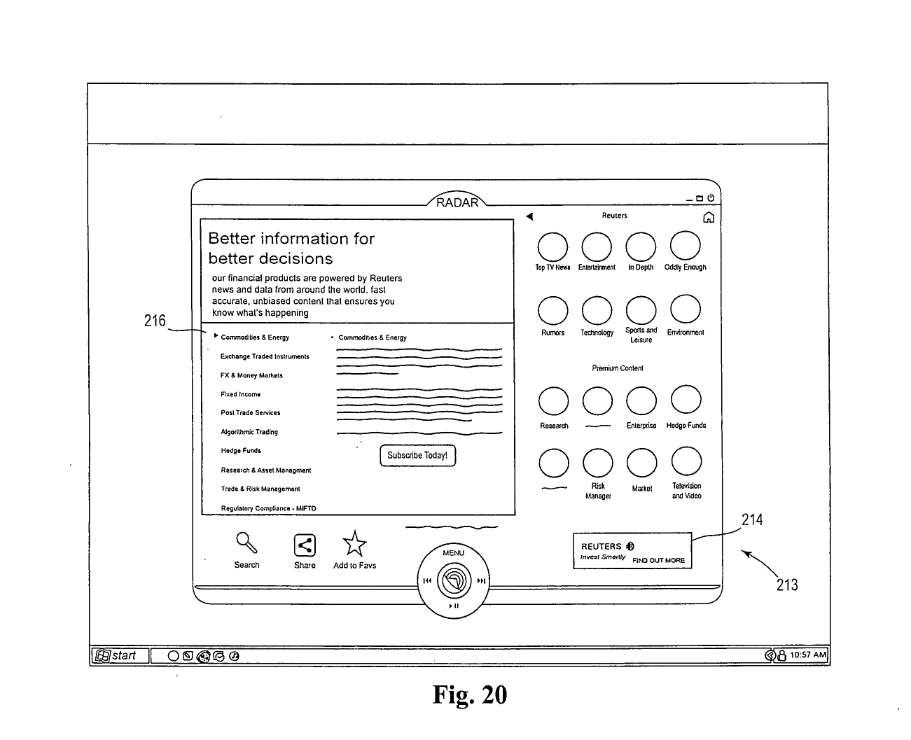

As illustrated in FIGS. 19 and 20, IEM 182 may be adapted to facilitate access to both free content, and premium or fee-based content. In the embodiment depicted, UI 301 displays a two-tier set of icons in menu region 135, while displaying active content in playback window 133. According to this embodiment, IEM 182 is adapted to display view UI 301 free content icons 210 appear in an upper portion of icon palette 135 and premium or fee-based content icons 212 appear in a lower portion of icon palette 135.

Unlike other technology, IEM 182 allows a user ready access to both free and premium content via a single UI 301. In one embodiment, IEM 182 is adapted to operate account manager 703 in order to access stored account information such as login ID and password such that IEM 182 may automatically access pay or otherwise limited access content.

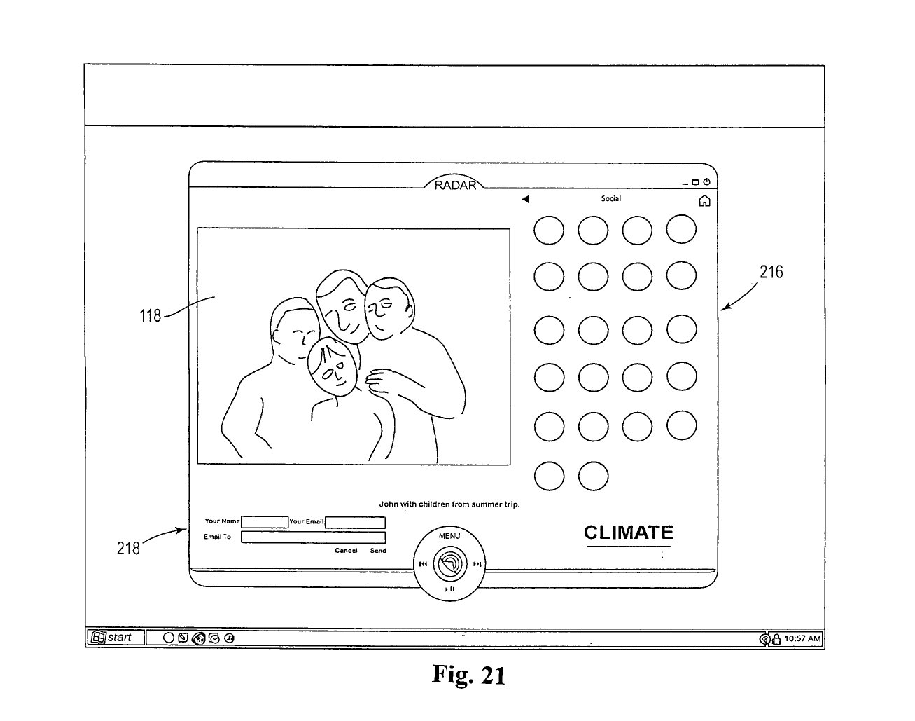

As depicted in FIG. 21, IEM 182 may also include ad system 213. Ad system 213 may be adapted to display, via UI 301, an ad banner 214 that when selected causes IEM 182 to display a full advertisement 216 in playback window 133. In various embodiments, account manager 702 is adapted to store and manage login of a multiplicity of different types of limited access sites in general and thus allow users to purchase goods and/or services view IEM 182. For example, IEM 182 may be adapted to display an advertisement for particular goods, and a user may be provided an ability to access credit card or other necessary purchasing information via account manager to easily purchase the advertised goods.

Account manager 702 and ad system 213 of IEM 182 may be adapted to facilitate integrated signup, purchase, and receipt tracking. Furthermore, ad system 213 may be adapted to provide contextual based advertisement selection by catering displayed advertisements to particular searches or other actions initiated by a user.

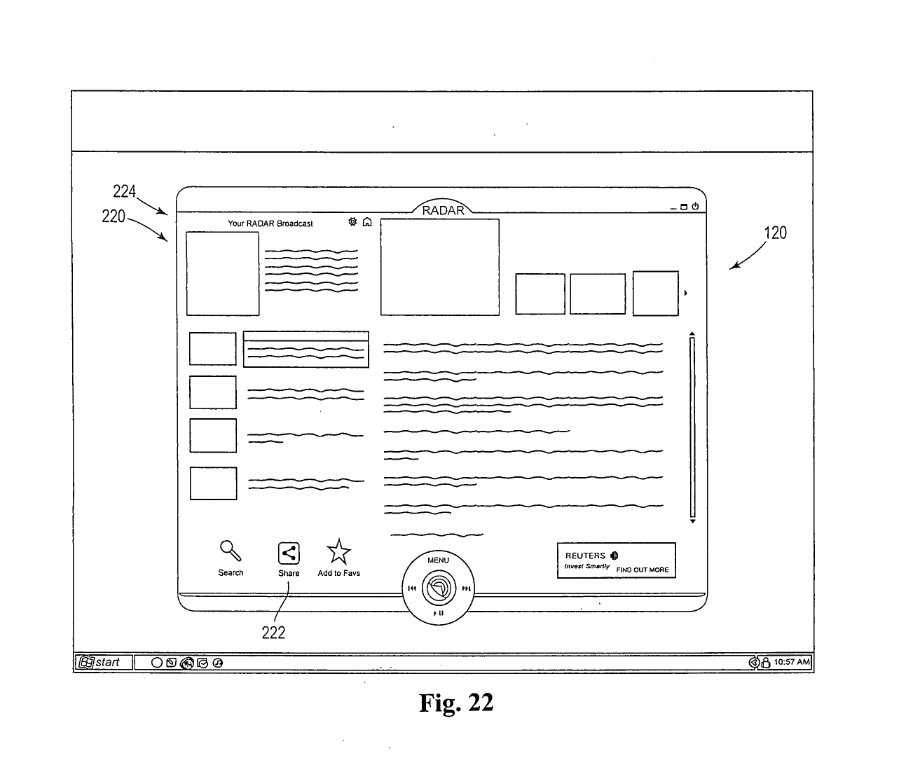

FIG. 22 illustrates one embodiment of IEM 182 that is adapted to provide users with a single source interface for social networking. According to the illustrated embodiment, icon palette 216 includes a plurality of icons that represent both social networking and content access sites. Accordingly, IEM 182 is adapted to, via account manager 702, automatically log in to both social networking and content access sites. For example, a user may be able to access one or more photos stored on the Flicker photo management site, and to post selected photos from that site to LinkedIn or Facebook. IEM 182 may also be adapted to provide a user with notifications of changes with such sites, such as by collecting and displaying messages from a plurality of sites in a single inbox. IEM 182 may further be adapted to allow a user to collectively communicate via multiple types of communication, for example by posting a single message to various social networking sites and by distributing that message via email.

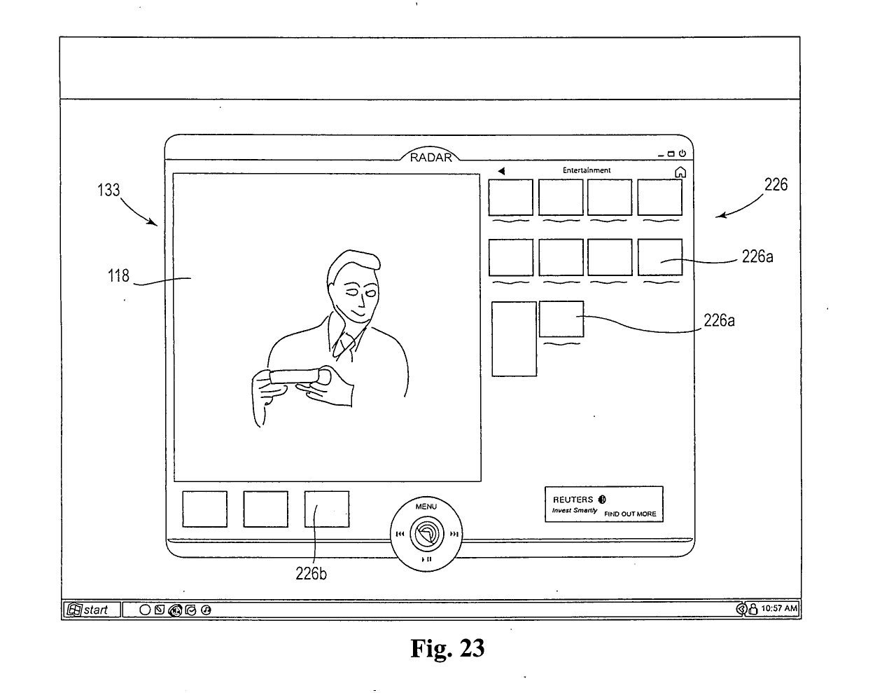

FIG. 23 illustrates IEM 182 adapted to provide users with an ability to create and broadcast personalized UI 301 broadcast page 220 to other IEM 182 users. In one such embodiment, a user may create and publish a broadcast while continuing to browse and view other media content. In an embodiment, a user is provide a selectable share icon 222 that is adapted to initiate broadcast of particular content. In some embodiments, IEM 182 may allow other users will see the creating user's broadcast page 220 instantly, along with instant updates. In addition, other users may receive notifications of such updates.

FIG. 24 illustrates one embodiment of a content aggregation queuing function of IEM 182. On the UI 301 page depicted in FIG. 24, content from an actively viewed site is displayed in playback window 133. Icon palette 135 is populated with a number of icons that represent content available to a user. In this example, the icon palette 135 displays icons 226 that represent entertainment-oriented content. In an embodiment, a user may select one or more of icons 226 and indicates that IEM 182 should begin acquiring content associated with selected icons. In one embodiment, selected icons may be graphically moved to queuing window 228. In various embodiments, queuing window 228 is selectable to be hidden from a user while content is being acquired by IEM 182. In various embodiments, a user may continue to browse, view, or search for content while IEM 182 is acquiring content.

In one embodiment, a user may right click on, shift click on, or through other means activates an entertainment icon 226, which causes IEM 182 to graphically move icon 226 to a queue window 228 located below playback window 133. In other embodiments, a user may drag icon 226 to queue window 228. As illustrated in FIG. 24, an icon 226a travels from icon palette 135 to queue window 228 indicating that content acquisition is in process. If IEM 182 has completed acquiring content, when icons 226 located in queue area 228 are clicked or selected, content from the selected icon 226 is immediately made available to a user.

In another embodiment, as depicted in FIG. 25, IEM 1802 may display content from a website in a manner that resembles a traditional web browser. Although content may be displayed in a traditional browser format, controls of UI 301 may still be utilized for navigation.

IEM 182 is an inherently multi-platform solution. Users may be provided with a plurality of selectable options to customize IEM 182. For example, a user may be provided with an ability to select channel or content provider preferences, skin options, notifications, or particular broadcasts. IEM 182 may be uniformly useable via a variety of media devices 203 and in a variety of configurations such as a desktop client, website, mobile device, or a set top box.

Finally, while the present invention has been described with reference to certain embodiments, those skilled in the art should appreciate that they can readily use the disclosed conception and specific embodiments as a basis for designing or modifying other structures for carrying out the same purposes of the present invention without departing from the spirit and scope of the invention as defined by the appended claims.

1. A system for a user interface that provides and manages access and aggregation of multimedia and communication digital content by a user over the Internet, the system comprising:
a user interface window presenting a common format across multiple platforms;
a player window defined within the user interface window, the player window including software adapted to present to the user via the player window a multiplicity of different types of digital content;
an icon palette defined within the user interface window, the icon palette including a multiplicity of graphically manipulable icons and software adapted to display and manipulate the multiplicity of icons, each icon associated with a given item of digital content; and
a graphic control interface including a plurality of graphically manipulable buttons and software adapted to control the manner in which the items of digital content associated with the multiplicity of icons are presented in the player window, the graphic control interface and the icon palette operating together to enable the user to manipulate a selectable plurality of the icons within the user interface window such that the items of digital content associated with each of the plurality of icons are aggregated and managed as a collective in response to the graphic control interface.
